(19) United States
(12) Patent Application Publication
(10) Pub. No.: US 2004/0078312 A1
(43) Pub. Date: Apr. 22, 2004

(54) Method and apparatus for providing comprehensive educational and financial services

(76) Inventors: Eric F. Bush, Centreville, VA (US); Nancy Deck, Washington, DC (US); James H. Eickhoff, Cincinnati, OH (US); Barry W. Goulding, Bethesda, MD (US); Douglas S. Hopkins, Sheridan, IN (US); Robert S. Leavitt, Alexandria, VA (US); Mark G. Overend, McLean, VA (US); Joshua D. Paul, Indianapolis, IN (US)

Correspondence Address: DICKSTEIN SHAPIRO MORIN & OSHINSKY LLP, 2101 L STREET NW, WASHINGTON, DC, 20037-1526, US

(21) Appl. No.: 10/638,501

(22) Filed: Aug. 12, 2003

Related U.S. Application Data
(60) Provisional application No. 60/410,315, filed on Sep. 13, 2002.

(51) Int. Cl. G06F 17/60

(52) U.S. Cl. 705/35

(57) ABSTRACT

The invention provides a system and method for providing access to financial aid products from a central location via the Internet. The system comprises a computer network, at least one server in communication with the computer network, and at least one product access Web Site linked to the server through the computer network, the Web Site providing a user interface through which a first user can select from among a plurality of financial aid products. The system also includes a sign-on module that interacts with the Web Site and controls access to at the financial aid products, wherein the sign-on module can provide access to the financial aid products after receiving valid login information a single time until the first user is logged out of the system.

### CROSS-REFERENCE TO RELATED APPLICATIONS

This patent application claims the benefit of U.S. provisional patent application Serial No. 60/410,315, filed Sep. 12, 2002, entitled METHOD AND APPARATUS FOR PROVIDING COMPREHENSIVE EDUCATIONAL AND FINANCIAL SERVICE. U.S. provisional patent application Serial No. 60/410,315 is hereby incorporated by reference.

### FIELD OF THE INVENTION

The present invention relates generally to a method and system and computer program for Internet World Wide Web-based services, and more specifically to a system and method for providing access to financial aid products.

### BACKGROUND OF THE INVENTION

With the advent of the Internet, more and more businesses in a wide range of industries have been adopting new technologies for improved access and service to customers. These technological advances have increased productivity and efficiency so that faster service, greater efficiency, greater effectiveness, and more customized solutions are becoming the expected norm. The increase in customer-oriented solutions has also had a positive impact on business-to-business transactions, as companies, individuals and other entities, including educational and financial institutions, are working together more to provide solutions to customers' needs.

Educational institutions and financial institutions have adopted technologies to improve service to financial aid consumers, such as students, potential students, and their families. For example, both educational and financial institutions may offer on-line information about financing a college or graduate education. Additionally, financial institutions may offer on-line forms for student loan applications. Financial aid consumers, however, may still be required to meet their financial aid need from a variety of locations.

For example, a student may fill out an on-line free application for federal student aid (FAFSA), entering a variety of demographic information. Subsequently, the student receives a financial aid award package, which includes a student loan, in the mail. The student may then be required to visit their school's financial aid office to receive loan counseling. After receiving the loan counseling, the student may then have to complete a student loan application on-line, which again requires entering much of the same demographic information previously entered for the FAFSA. Accordingly, the financial aid process may be cumbersome, inconvenient, and inefficient.

Although portions of the process for obtaining student loans may be completed on-line, there is still a need for a system and method allowing improved service to customers from educational and financial institutions. More specifically, there is a need for a system and method to provide secure student loan processing and other financial aid products for students and their families that is completely Internet-based.

### BRIEF SUMMARY OF THE INVENTION

The invention provides a system and method which allows users, financial aid professionals and students, to interact and to access financial aid products from a central location via the Internet. Briefly described, the system comprises a computer network, at least one server in communication with the computer network, and at least one product access Web Site linked to the server through the computer network, the Web Site providing a user interface through which a first user can select from among a plurality of financial aid products. The system also includes a sign-on module that interacts with the Web Site and controls access to the financial aid products, wherein the sign-on module can provide access to the financial aid products after receiving valid login information a single time until the first user is logged out of the system.

### BRIEF DESCRIPTION OF THE DRAWINGS

Additional features of the present invention will be apparent from the following detailed description and drawings which illustrate exemplary embodiments of the invention.

FIG. 1 is a block diagram illustrating a system for providing educational financial aid services according to an exemplary embodiment of the invention.

FIG. 2 is a diagram illustrating the configuration of a Site editor module according to an exemplary embodiment of the invention;

FIG. 3 is a screen view of an exemplary main menu segment of the Site editor module;

FIG. 4 is a screen view of an exemplary home page of a Web Site created using the Site editor module;

FIG. 5 is a screen view of an exemplary portion of a Web Site created using the Site editor module;

FIG. 6 is a diagram illustrating a save function for the Site editor module according to an exemplary embodiment of the invention;

FIG. 7 is a diagram illustrating a Site usage monitoring function of the Site editor module according to an exemplary embodiment of the invention;

FIGS. 8 through 10 are screen views of exemplary segments of the Site editor module;

FIG. 11 is a diagram illustrating the configuration of a management module according to an exemplary embodiment of the invention;

FIGS. 12 through 25 are screen views of exemplary segments of the management module;

FIGS. 26A-26B are diagrams illustrating methods for using the single sign-on module according to exemplary embodiments of the invention;

FIG. 27 is a diagram illustrating the architecture of the single-sign-on module according to an exemplary embodiment of the invention; and

FIG. 28 is a diagram illustrating the architecture for supporting a system and method for providing educational and financial services according to an exemplary embodiment of the invention.

### DETAILED DESCRIPTION OF THE INVENTION

In the following detailed description, reference is made to the accompanying drawings, which form a part hereof and show by way of illustration specific embodiments that the invention may be practiced. These embodiments are described in sufficient detail to enable those skilled in the art to practice the invention, and it is to be understood that other embodiments may be utilized, and that structural and logical changes may be made without departing from the spirit and scope of the present invention. The progression of process steps described is exemplary of embodiments of the invention; however, the sequence of steps is not limited to that set forth herein and may be changed, with the exception of steps necessarily occurring in a certain order.

In the following detailed description, the term “school” refers to any educational institution, such as, but not limited to, universities, colleges, and technical schools. Additionally, a school may refer to a component of a larger school system. For example, a university may have component schools, such as a law school and a medical school.

The term “student” refers to any person enrolled at a school, as well as, a prospective student of a school. The term “student” may also include any person acting on behalf of such a student, for example, a parent or guardian.

The term “user” may be any person using any portion of the system. Typically, users of different portions of the system will be different types of persons. For example, a typical user of a product access Web Site will be a student or a person employed in a school's financial aid office (FAO). A typical user of the Site editor module will be a school representative, and more specifically a representative of the school's FAO. A typical user of the management module will be a representative of the system administrator (owner), and more specifically, a representative of a financial institution engaged in the business of providing educational financial aid. A user accesses the system using a computer, which is referred to as a “client computer” or “client.”

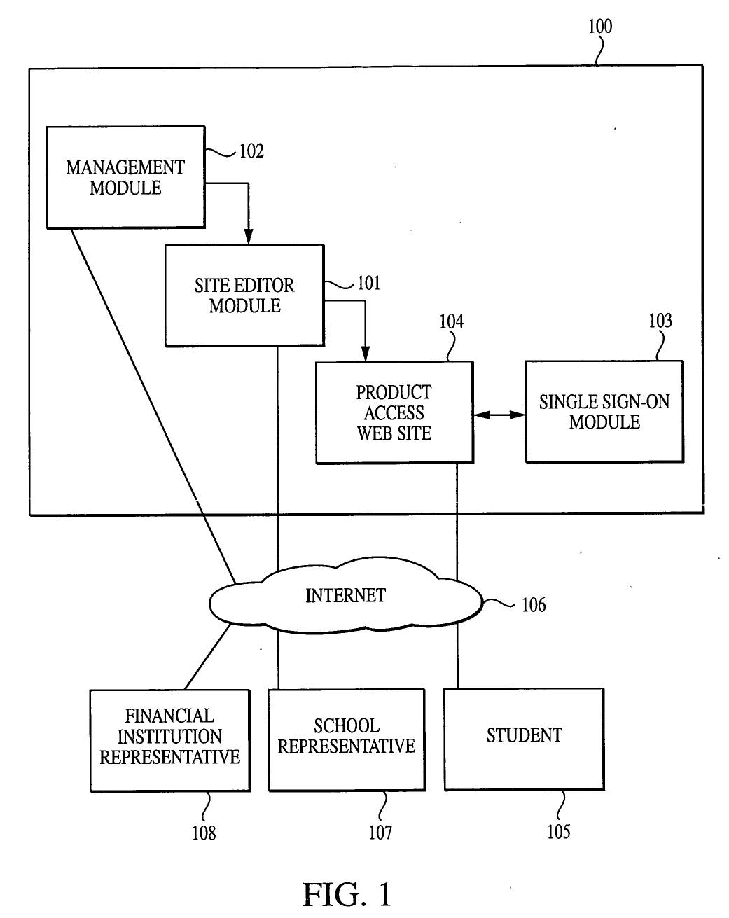

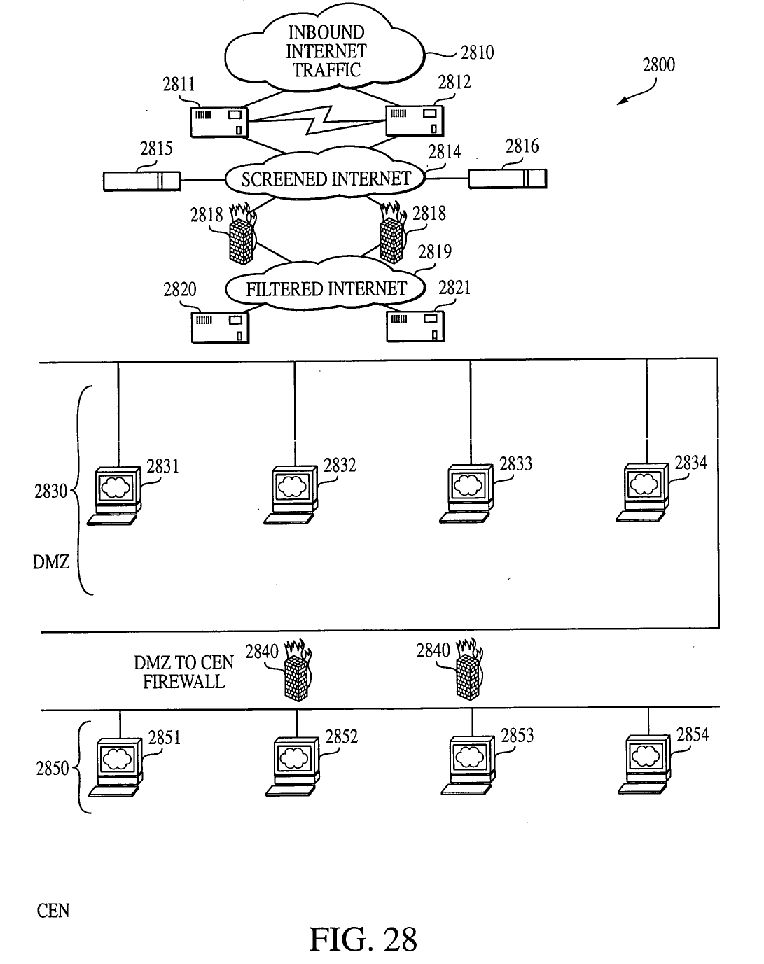

FIG. 1 is a block diagram illustrating a system 100 according to an exemplary embodiment of the invention. The system 100 allows users, for example, financial aid professionals and students, to interact with and have access to financial aid products from a central location via the Internet 106. The system 100 offers access to products that provide complete on-line student loan processing, as well as additional financial aid and other products to a user 105 of a product access Web Site 104 located in the system 100. A financial aid product may be any information, service, or product related to the financial aid process, such as loan counseling services, applications for financial aid or loans, services for consolidating loans, among many others. Other products (or services or information) may be directed at the ancillary needs of students, such as general financial products, e.g. credit card products, and career related products, among others. Products may be located on different Web Sites within the system or external to the system (FIG. 28).

The system 100 includes a Site editor module 101 that provides a user, typically a school representative 107, with the ability to create a product access Web Site 104 tailored to the financial aid needs of Web Site users 105, such as the school's students and/or FAO. Using the Site editor module 101, a school representative 107 can create a Web Site 104 that provides Web Site users 105 access to any number of products available through the system. For purposes of this detailed description, a Web Site is an individual set of Web Pages that may be visited by a Web Browser. A product access Web Site 104 created using the Site editor module 101 is located on a system server (not shown).

The system 100 also includes a management module 102 for managing features of the Site editor module 101. The management module 102 allows a user representing the system administrator, typically a financial institution representative 108, to manage the features of the Site editor module 101, such as the products links available, the schools included, and the users (school representative 107) of the Site editor module 101 for each school. Both the Site editor and management modules 101 and 102 are Web-based. Accordingly, school and financial institution representatives 107 and 108 may use the Site editor and management modules 101 and 102, respectively, via the Internet 106. As noted above, each user 105, 107, and 108 accesses the system using a client computer that communicates with the system over a network backbone.

In an exemplary scenario, a student 105 navigates the product access Web Site 104 created by a school representative to a link to an electronic award product, which allows the student 105 to view his/her award package. After accessing the link to the electronic award product, the student 105 logs into the system via the electronic awards Site.

The system includes a single sign-on module 103 that allows the student 105 to log into the system 100 one time from a single point and passes the student's authentication information and data associated with the student, such as demographic data, to other products the student 105 accesses through the system 100. Accordingly, once the student 105 logs into the system 100, the single-sign on module 103 will pass authentication information and the student's data to other products that the student 105 navigates to until the student logs out of the system 100. Therefore, if the student 105 is awarded a student loan as part of his/her financial aid package, the student 105 applies for their student loan using a student loan product and completes required entrance counseling using an entrance counseling product without having to separately log on to each product.

For this, the student 105 navigates to and selects a link to the entrance counseling product on the product access Web Site 104. The single sign-on module 103 passes authentication information to the product so the student 105 does not have to log in again. The single sign-on module 103 also passes data associated with the student from a system database to this product. The data, for example, name, address, and date of birth, is pre-populated to the appropriate fields of any form within the product so that the student 105 does not have to enter the data. Where data is incorrect, the student 105 may change the information on the form. The new, updated data replaces the incorrect data in the database to update the data.

When the student 105 completes his/her entrance counseling, the student can then apply for a loan. For this, the student navigates the product access Web Site 104 to a student loan product link. The student loan product may contain loan application forms that may be completed and submitted via the Internet 106, as well as information regarding the loan application process. At this point, the single sign-on module 103 passes authentication information and updated data to the loan application forms. The updated data is pre-populated into the forms so the student 105 does not have to enter the information again. The student 105 may complete only the remaining unpopulated fields and electronically sign and submit the application. Using the system 100, the student 105 may complete his/her student loan process and access financial aid and other products from a central location via the Internet to meet his/her financial aid needs efficiently and conveniently.

Aspects of the invention, including the Site editor module 101, the management module 102, and the single sign-on module 103 are described below in more detail.

### Site Editor Module

The Site editor module 101 allows a user to create, modify, and monitor a product access Web Site 104. Illustratively, the Site editor module 101 is a computer program application product embodied on a computer useable medium and includes a number of code segments. The Site editor application runs on a system server, which is in communication with a computer network. The server including the Site editor module 101 can be part of a network having an architecture described below in connection with FIG. 28. Accordingly, the Site editor application has access to a system database storing data related to features of the Site editor module 101.

The creation and modification segments of the Site editor module 101 provide a user interface through which a user can create and/or modify a product access Web Site 104 using preset and or/customized features according to a preset process. A user interacts with a user interface, for example a Web Page that is part of a Site editor Web Site and is displayed on a screen of a client computer, according in part to instructions provided thereon and provides input related to the preset process. The Site editor module 101 receives the input. Accordingly, a user need not be skilled in the art of Web Site creation or design in order to successfully use the Site editor module 101 to create or modify a product access Web Site 104.

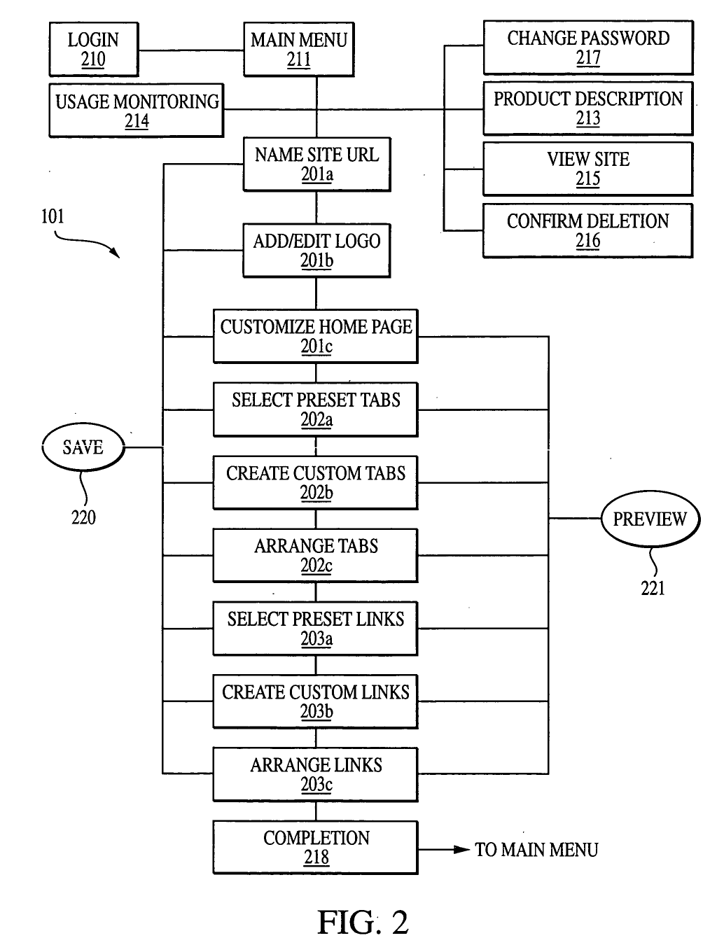

FIG. 2 is a diagram illustrating an exemplary configuration of the Site editor module 101. Segments of the Site editor module 101 allow a user to create and/or modify a Web Site using a prescribed process. As the process is exemplary only, the particular segments and the sequence of the segments may be modified without departing from the spirit of the invention.

A product access Web Site created or modified using the Site editor module 101 will provide the product consumer(s), such as students or FAO(s) with access to products from the system 100. An exemplary Site editor user is a school representative who could use the Site editor module 101 to create one or more product access Web Sites tailored to provide a product access Web Site user with financial aid products and other products. Further, a user can create a Web Site tailored to a particular type of product access Web Site user. For example, a school representative can create a Web Site tailored to the school's FAO staff and a one or more Sites tailored to the school's students. As a school may have different types of students, a user can create a Web Site tailored for each type of student. For example, a university representative can create a Web Site tailored to the needs of its undergraduate students and their parents, and also create Web Sites for each of its graduate programs tailored to the needs of its graduate students in those programs.

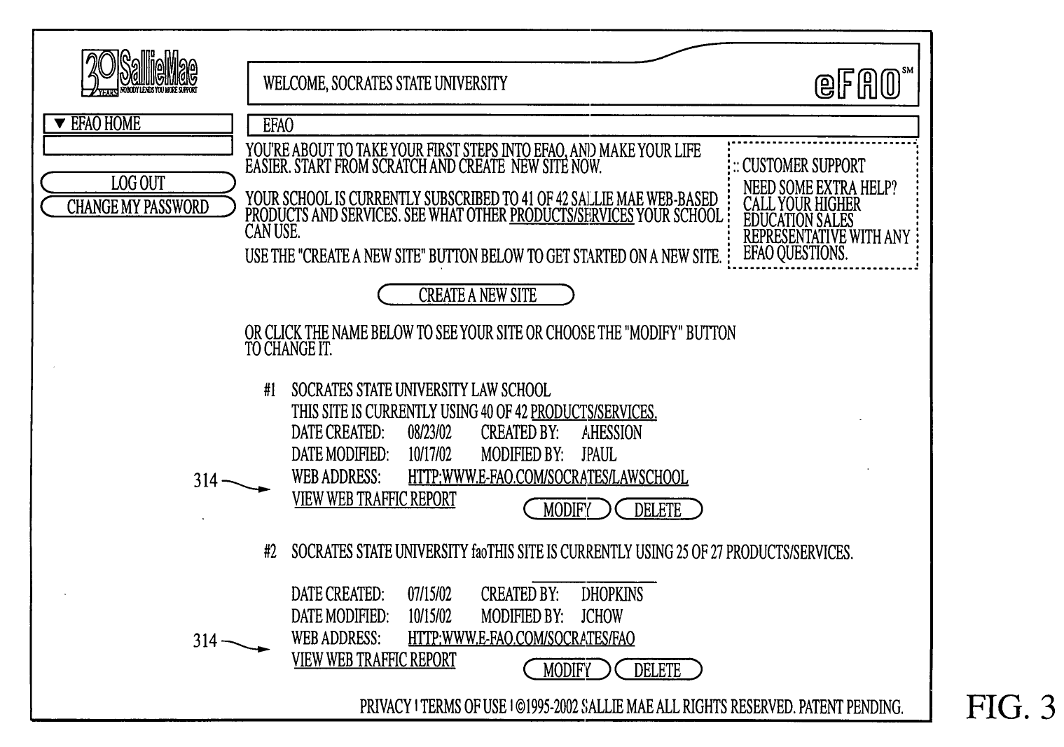

The user enters the Site editor module 101 through a login segment 210. The user is required to enter login information to identify the user to the system and for security, such as a user identification and password, to proceed to further segments of the process. Upon successfully logging in, a user is provided with a number of options in a main menu segment 211. A screen view of an exemplary main menu 211 segment is shown in FIG. 3. Illustratively, the user is provided with the option to view the usage of an existing Web Site, view or delete an existing Web Site, view products to which the user can subscribe, change their password, and create or modify a Web Site.

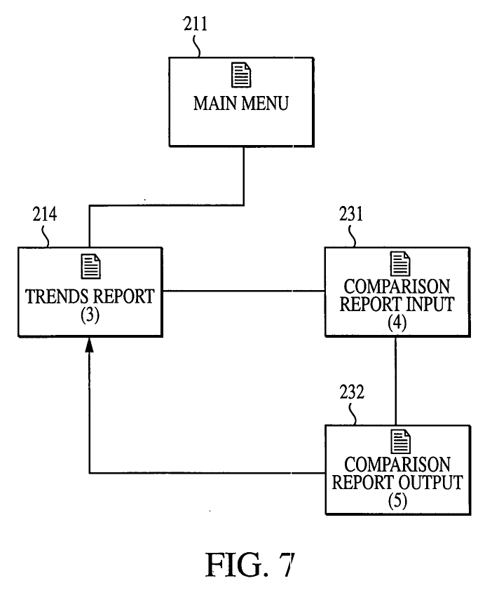

When a user chooses to view the usage of an existing Web Site, the user is taken to a usage monitoring segment 214, which is described in more detail below in connection with FIG. 7. When a user chooses to view an existing Web Site, the user is taken to the Site in segment 215. When a user chooses to delete an existing Web Site, the user is taken to a confirm deletion segment 216 and asked to confirm the selection in order to prevent the deletion of a Web Site by mistake. When a user chooses to view products, the user is taken to a product description segment 213, which contains information about the products and/or further options for the user regarding the products. When a user chooses to change their password, the user is taken to a change password segment 217.

When a user chooses to create or modify a Web Site, the user accesses the first segment 201 of a creation or modification process depending on whether the user has an existing Web Site or not. The creation and modification processes may be identical, except that for a modification process, the user will be working with an existing Web Site. The options and menus for both processes may be identical. For simplicity, the creation process is described in connection with FIG. 2, but the description is generally applicable to the modification process also.

In segments 201a through 201c, the user creates a Web Site by naming the Site, adding images, such as a logo and pictures, and customizing the home page of the Site. In segments 202a through 202c, the user an also add other features to the Web Site by choosing and creating tabs, and arranging the tabs for the Site. The user can also select links to products, create links, and arrange the links for the Site in segments 203a through 203c. The arrangement of steps described in connection with FIG. 2 does not pre-suppose a particular order to the Web Site creation or modification process set forth above.

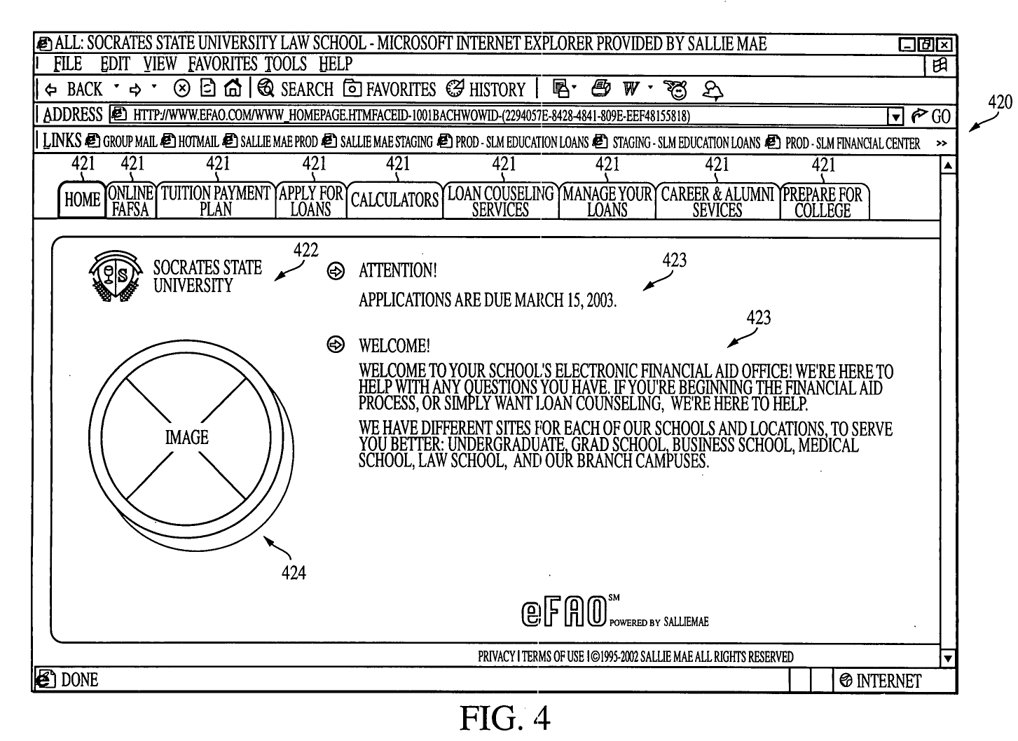

The user may exit the Site editor module 101 at any point in the process and may save the completed work to avoid losing work already completed. Additionally, the user may view the Web Site as the user creates the Site. Thereby, the user may immediately determine whether the Site is to his/her liking. FIG. 4 is a screen view of a home page of an exemplary Web Site created using the Site editor module 101. Save and preview features of the Site editor module 101 are described in more detail below.

In segment 201a, the user establishes a Uniform Resource Locator (URL) for the Web Site. Once established, the URL can be entered in the location field of any Web Browser to access the home page of the Web Site as created by the user in segment 201c below. The domain name is such that the Web Site created by a user will be located on a system server.

For example, where the user is a representative for a school and is seeking to create a financial service Web Site for students, the user may create a Web Site for their school, which is tailored to serve students. For this, the user will enter the Site editor module 101 and proceed to segment 201a to create a Web Site. The user may choose a subdirectory name for their Web Site. The Web Site will be located on a system server and will have a domain name accordingly. The domain name may be, for example, “www.system.com/school/name,” where “system” is the domain name for a system server, “school” is the directory for the user's school and “name” is the subdirectory name chosen by the user in segment 201a. If the user sets up a Web Site for students at their school, the user may, for example, name the Site “student.”

The user may establish a number of subdirectories, and, therefore, a number of Web Sites for a particular directory. For example, the user may also create a Web Site for the school's FAO.

If the established URL is entered into a Web Browser location field, when the browser locates the appropriate school Web Site on the system server a string of realized database queries will appear in the Web Browser location box. Hence, the URL simply disguises a resulting database query. In this manner, the user can easily remember and disseminate the URL to potential users of the created Web Site, instead of having to use a Web address with a long database query string attached. Further, the URL can easily be entered into a Web Browser location field by a user of the Web Site, such as a student.

The user may then proceed to segment 201b, where the user is presented with the option to add images to the Web Site. For example, the user can add their school logo 422 and choose colors for the logo. In segment 201c, a user is presented with the option of customizing the Site's home page. As shown in FIG. 4, a user can add messages 423 or additional images 424 to be displayed in particular places on the Site's home page 420.

In segment 202a, the user is presented with the option of selecting preset tabs for the Site. A tab is an organizational feature that promotes logical and convenient organization. Preset tabs have a predetermined name and are preset using the management module 102 described below. In a Web Site created using the Site editor module 101, tabs are used to organize links to products as described below in connection with segments 203a through 203c. As depicted in FIG. 4, the tabs 421 can be, for example, “Online FAFSA,” “Tuition payment plan,” “Apply for loans,” “Calculators,” “Loan counseling services,” “Manage your loans,” “Career & alumni services,” and “Prepare for college,” as shown in FIG. 4.

By presenting preset tabs for the user, the user can quickly and easily configure their Web Site. In segment 202b, the user is also presented with the option of creating his/her own tabs. Thereby, the user can customize the Web Site to fit his/her individual needs. In each of the segments 202a and 202b, the user can also select to deactivate or activate particular tabs. When a tab is deactivated, the tab will not appear on the product access Web Site. In segment 202c, the user arranges the tabs that will appear on the product access Web Site. For example, the user arranges the order in which the tabs will appear.

In segment 203a, the user is presented with the option of choosing links associated with each tab. Links associated with a particular tab will appear under the tab when a user of the product access Web Site selects the tab. Each of the links is to a product. Accordingly, the links can be to services, such as loan applications, loan consolidation, and the like. The links can also be document links that provide a user of the product Web Site access to a document, such as textual information regarding loan types.

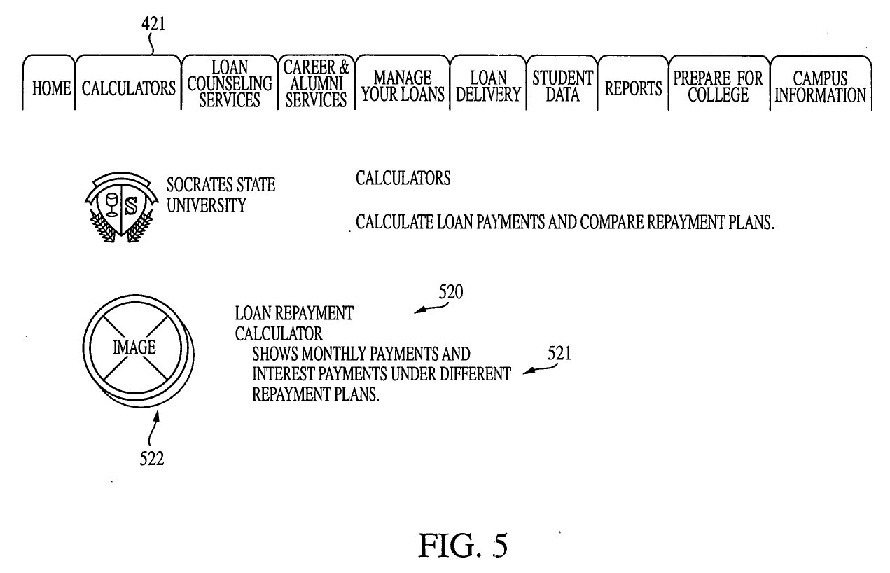

Each of the preset tabs can be associated with a number of preset links. If the user chooses a particular tab, the user then chooses which of the available links the user would like to appear under that tab on the product access Web Site. For example, “Apply for Loans,” can have preset document links to information regarding different types of loans such as graduate, undergraduate, and Law loans, as well as preset service links that allow a student to apply for a loan. The user chooses one or more links for each preset tab. Thereby, the user can quickly and easily tailor the Web Site to provide financial aid and other products to the product access Web Site's intended users. FIG. 5 is an exemplary screen view of a page of a product access Web Site illustrating a link 520 under the tab 421 “Calculators.” The link 520 is to a loan repayment calculator product. Each link can have an associated description 521 and/or an image 522 to allow Web Site users to quickly understand the product(s).

In segment 203b, the user is presented with the option of creating custom links for either the preset tabs or the custom tabs. The user is instructed how to create a link. For example, where the user chooses to create a link to another Web Site, the user is instructed to provide the other Web Site's URL. The user can also name the link, provide a description of the link that will appear with the link under the tab, and choose an image to appear with the link under the tab.

After a user has chosen and created the links as desired, the user then arranges the links in a desired order in segment 203c. After a user has completed segment 203c, the user may be directed to a completion segment 118, from which the user may exit the system or return to the main menu segment 111.

As shown in FIG. 2, once a user has entered the creation process, the user can go to any of the segments 201a through 203c from another segment 201a through 203c. For example, if the user is at segment 202a, the user can return to segment 201c. Alternatively, the user can advance to segment 203a without going through segments 202b or 202c. Thereby, a user can quickly and efficiently navigate the creation process. Also, the user can exit the Site editor module 101 from any of the segments of the Site editor module 101.

### Save Function

As shown in FIG. 2, the Site editor module 101 includes a save function 220. Using the save function 220, the user can save the additions/modifications of the Web Site to a system database from each segment 201a through 203c of the Web Site creation/modification portion of the Site editor module 101. Thereby, a user can complete only a portion of the Web Site at a time, without having to schedule time enough to finish the entire Site. Likewise a user who is modifying an existing Site can make only a portion of their desired changes at a time. Also, if the user is interrupted, the user can exit the Site editor module 101 at any point without losing any of the work already completed.

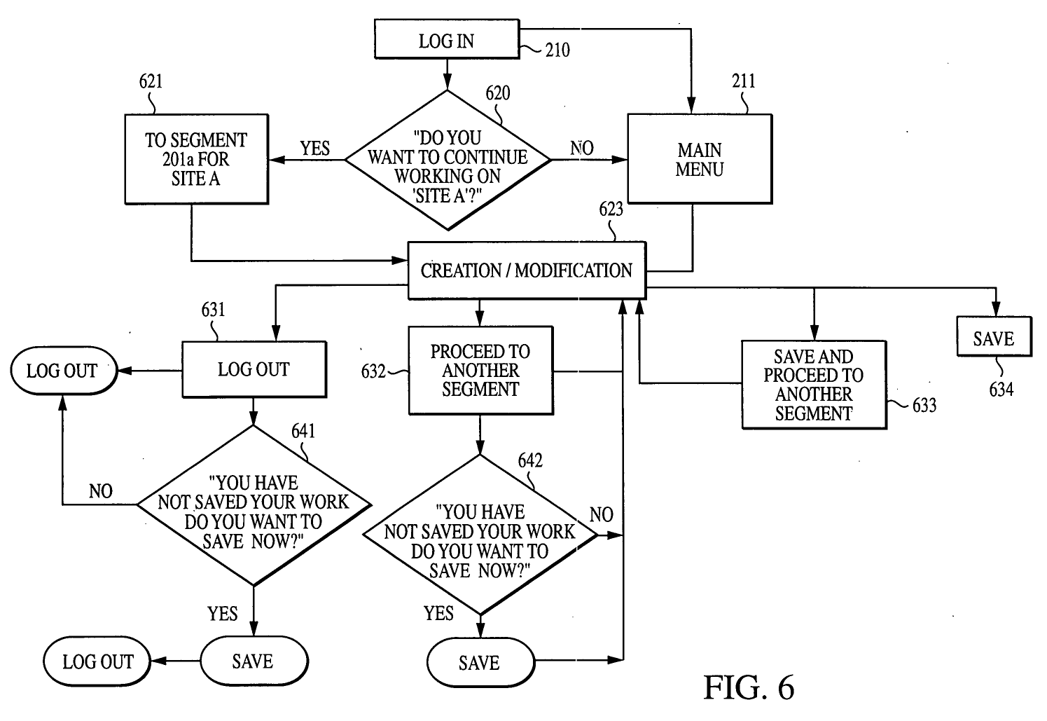

FIG. 6 is a flow chart illustrating an exemplary embodiment of the save function 220 for the creation/modification portion of the Site editor module 101. When a user has previously exited the Site editor module 101 from any segment 201a through 203c within the creation/modification process, the user may be presented with the option of returning directly to segment 201a of the creation/modification process for the Web Site on which the user was previously working when the user logs in again from login segment 210. For example, the user is presented with the message 620 “Do you want to continue working on ‘Site A’?” If the user chooses to continue working on Site A, the user is taken to segment 201a for Site A in segment 621. Thereby, the user can immediately pick up with the creation/modification process of a particular Web Site. Alternatively, the user may choose not to continue with the creation/modification process of Site A. In such a case, the user is taken to the main menu segment 211.

In each segment 201a through 203c of the creation/modification portion of the Site editor module 101, generally illustrated by reference numeral 623, the user is provided with the option to: log out, 631; proceed to another segment of the creation/modification process, 632; save and proceed to another segment, 633; and save work from the current segment, 634.

Where the user selects the log out option 630 or to proceed to another segment option 632 and the user has not saved any portion of his/her work, the user is presented with the option to save the work before logging out or proceeding to the selected segment. For example, if a user chooses to log out or proceed to another segment and the user has not saved any portion of their work, the user may be presented with messages 641 and 642, respectively, “You have not saved your work. Do you want to save now?” alerting the user that a portion of their work has not been saved. Upon receiving the message 641 or 642, the user can save the work or continue without saving the work. Where the user continues without saving the work, the work is lost.

Where a user has saved all of his/her work and selects the logout option 631 or to proceed to another segment option 632, the user is not presented with the option of resaving their work. In this manner, the user need not complete an unnecessary task and may log out of the Site editor module 101 more efficiently. For example, where a user has saved their work from the current segment and selects the log out option 631 before completing any additional work, the user is logged out of the Site editor module 101 without being presented with the option of saving their work. Likewise, where a user has saved their work from the current segment and selects to proceed to another segment option 632 before completing any additional work, the user is taken to the selected segment without being presented with the option of saving their work.

### Site Preview

Using the Site editor module 101, the user can preview the appearance of the Web Site during the creation process. In this manner, a user can view a representation of the product access Web Site that reflects the input the user has made in the creation/modification process at a time the input is received.

Referring to FIG. 2, segments of the Web Site creation and modification process may each have a preview link 221, which allows the user to view the portion of their Web Site related to the segment of the process that the user is engaged in. Illustratively, segments 201c through 203c have preview links 221 to allow a user to preview the Web Site as it appears at the time of preview. For example, if a user selects the preview link from segment 201c, the user is presented with the actual view of their Web Site home page. The user can view, for example, the school logo, any text or images the user has placed on the home page in segment 201c and the preceding segments.

Where the Site was previously created and the user is modifying an existing Site, the user can view features previously created in subsequent segments of the process, such as Site tabs, which will be populated with all previously selected links.

Alternatively, the preview link 221 can be eliminated and the portion of the user's Web Site related to the segment the user is engaged in is displayed on each of the segments 201a through 203c. For example, when a user is at segment 201c, the user is presented with the actual view of their Web Site home page. As the user adds text and/or images to the home page in segment 201c, the user can view the changes to the home page as the user makes them.

### Site Usage Monitoring

As noted above, the user can access a usage monitoring segment 214 from the main menu 211 of the Site editor module 101. A usage monitoring segment 214 may exist for each product access Web Site associated with the user. The usage monitoring segment 214 collects data related to the usage of a product access Web Site and provides a user interface through which the user can view the data.

In the example of FIG. 3, there are two Web Sites for the user and each Web Site has a link 314 to a respective usage monitoring segment 214. By accessing the usage monitoring segment 214 for a Web Site, the user can view the usage of their Site and the trends of the usage. Illustratively, usage is determined by the number of times the Web Site has been accessed. Additionally, the user can ascertain what portions of their Web Site have been accessed, as well as when and how often those portions were accessed. For example, the user can ascertain the usage trends of a particular tab on a Site. With such information, the user can, for example, modify the Web Site by placing frequently used tabs in a prominent position.

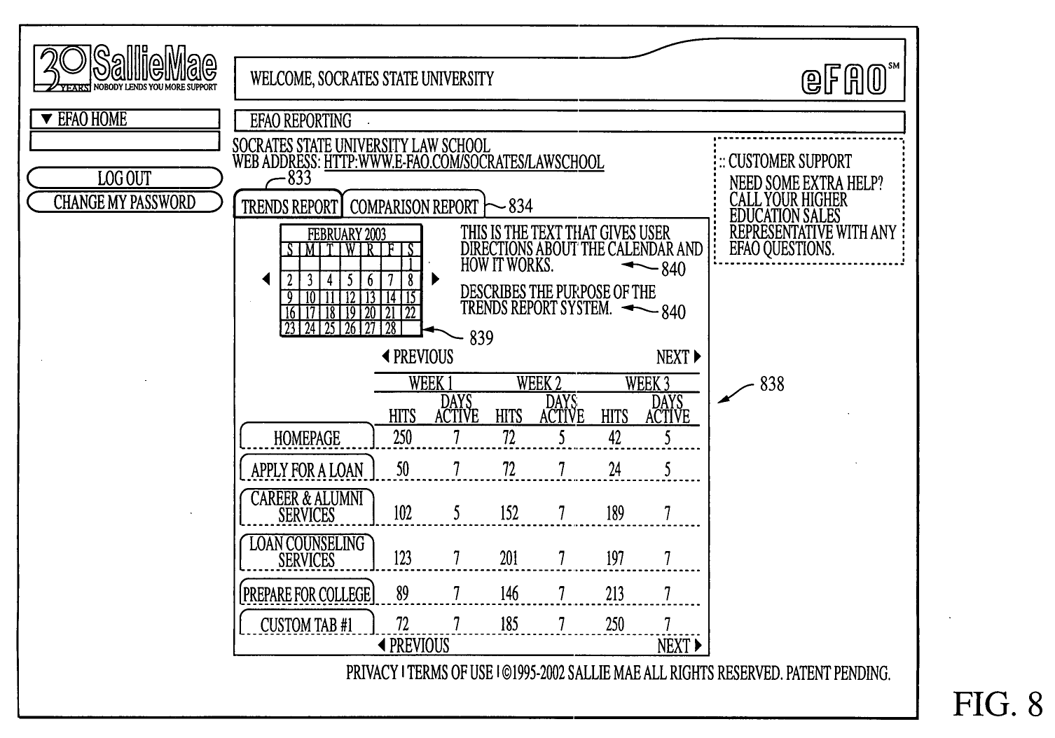

An exemplary embodiment of the usage reporting portion of the Site editor module 101 is illustrated in FIG. 7. An exemplary screen view of the usage monitoring segment 114 is shown in FIG. 8. In this example, the usage monitoring segment is a trends report segment 214 as the default tab is the trends report tab 833. From the trends report segment 214, the user can view a trends report under the trends review tab 833. As shown in FIG. 8, the user can view the number of times their Web Site was accessed for desired date ranges on a tab-by-tab basis.

A user can select a date range in a number of ways. In the example of FIG. 8, there is a default range for the current week and the two previous weeks displayed when the user enters the trends segment 214. The user can also select any calendar week using the calendar icon 839. There are also instructions 840 for using the segment features, such as the calendar icon 839, provided in the trends report segment 214. In addition to showing the number of times each tab was accessed, the trends report also displays the number of days a particular tab was active during the specified date range. Since the user has the ability to activate or deactivate a tab any time, the “days active” field 838 informs the user what portion of the date range a particular tab was active so that the user can better evaluate the trends report information.

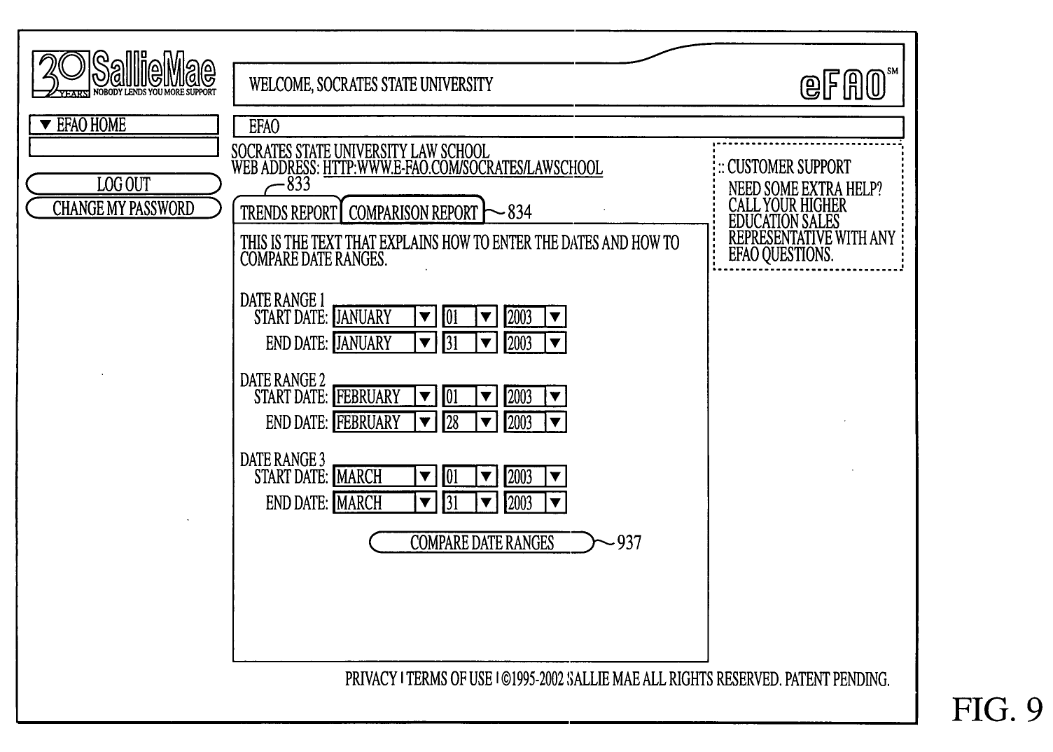

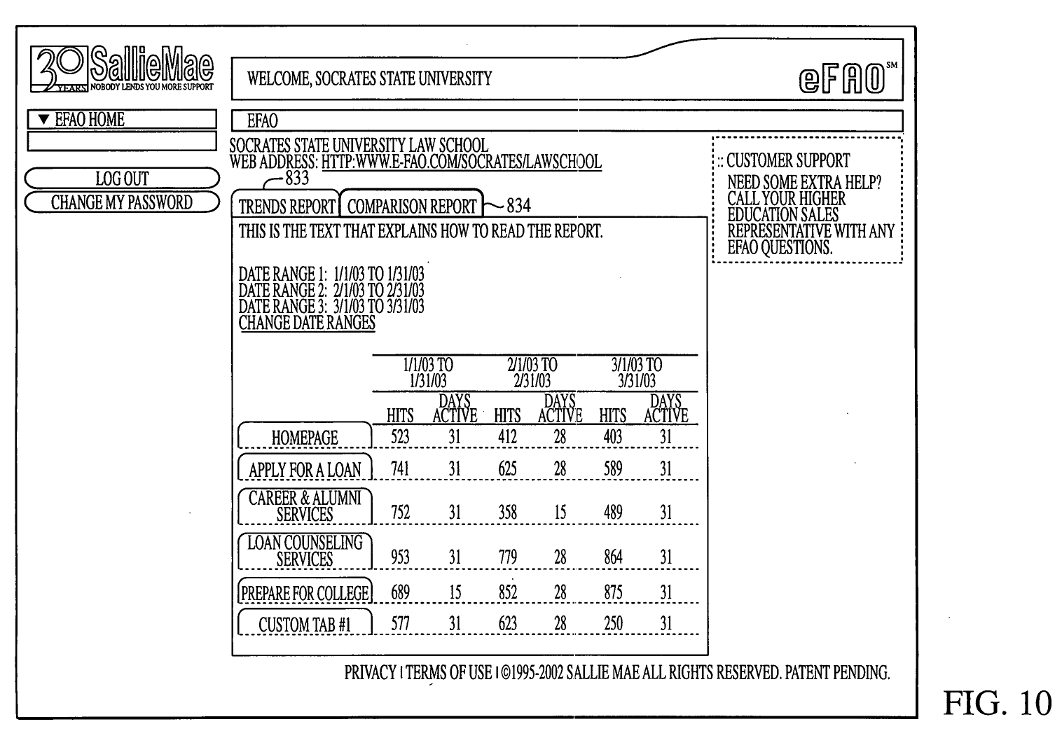

A user can also choose to view a comparison report under the comparison report tab 834. For this, the user selects the comparison report tab 834 and is taken to the comparison report input segment 231. A screen view of an exemplary comparison report input segment 231 is shown in FIG. 9. Illustratively, the user can select a number of date ranges for comparison. In the example of FIG. 9, the user can select up to three date ranges. When the user has selected the desired date ranges the user can view a usage report for those date ranges on the comparison report output segment 232, by selecting the “compare date ranges” link 937. FIG. 10 is a screen view of an exemplary comparison report output segment 232, which is configured similarly to the trends report segment 214, except that the usage information corresponds to the date ranges are the date ranges entered in the comparison report input segment 231.

### Automatic Translation

Web Sites created using the Site editor module 101 may be configured to include an automatic translation feature for providing textual information included on a Web Site in a language other than the default language. For example, where a default language is English, the automatic translation feature may translate the Web Site into Spanish. A link to the translated Web Site may be provided on, for example the Web Site's home page. Such a feature can be provided by a computer program application product as is known in the art. The Site editor user can be provided with the option of selecting the automatic translation feature for their Web Site or not, for example, as shown in segment 201a.

Additionally, the Site editor module 101 (and/or the management module 102 described below) may also include an automatic translation feature. For example the main menu segment 211 (1102) can have a link to the automatic translation feature. Thereby, the user can use the Site editor module 101 (or management module 102) without understanding the default language.

### Voice Interface

In addition to a visual user interface, such as a screen interface described above, the Site editor module 101 can also have a voice user interface. This enables a user to interact with the Site editor module 101 by voice, for example over a telephone. Thereby, a user may create or modify a Web Site by voice. For this, the system can include an interactive voice response (IVR) system, or other voice input enabling device or application as is known in the art.

### Management Module

Referring back to FIG. 1, the system 100 also includes a management module 102 for managing portions of the Site editor module 101. Illustratively, the management module 102 is a computer program application product embodied on a computer useable medium and includes a number of code segments. The management application can run on a system server that is in communication with a computer network. The server, including the management module 102, can be part of a network having an architecture described below in connection with FIG. 28. Accordingly, the management application has access to a system database storing data related to features of the management module 102.

The management module 102 provides a user interface through which a management module user can affect portions of the Site editor module 101. The user can interact with the user interface to provide input related to the portion of the Site editor module 101. The management module 102 receives input related to the portions of the sited editor module 101.

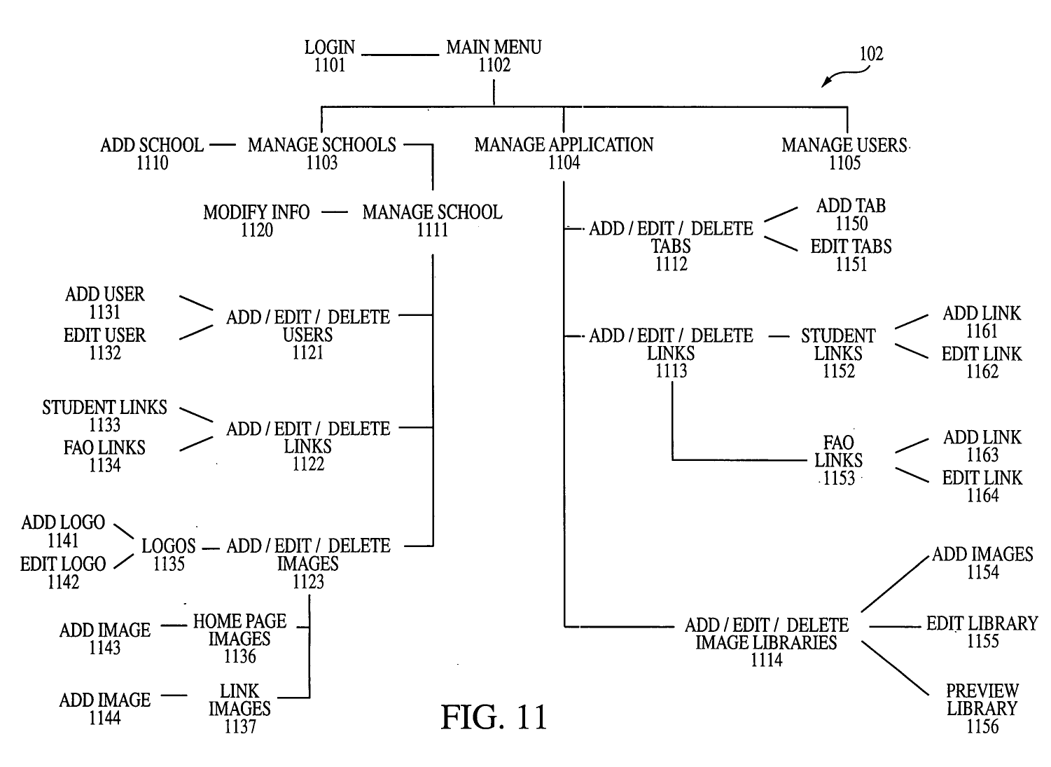

FIG. 11 is a diagram illustrating an exemplary configuration of the management module 102. Illustratively, the management module 102 is a Web-based application. The management module 102 allows a user to manage features of the Site editor module 101 in part by following instructions provided on a user interface in the segments of the management module 102. Accordingly, a user need not be skilled in the art of software application design in order to effectively manage features of the Site editor module 101.

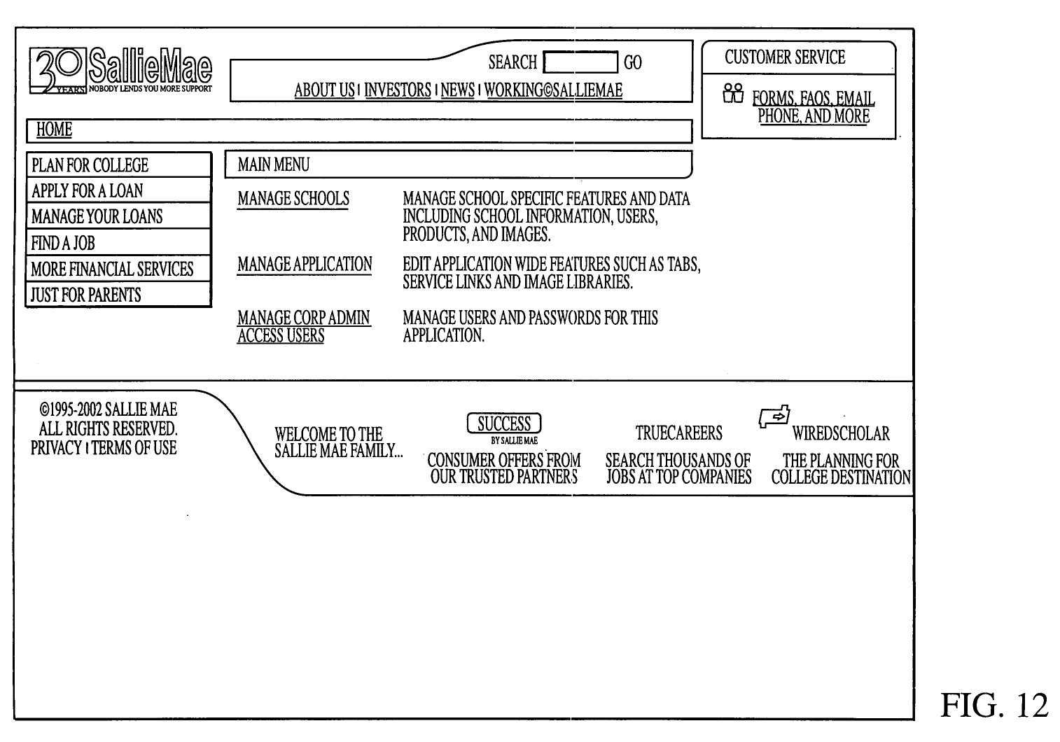

The user gains access to the management module 102 by logging into the system from a login segment 1101. Illustratively, the user enters a user name and password. Upon successfully logging into the system, the user is taken to the management module main menu segment 1102. A screen view of an exemplary main menu segment 1102 is shown in FIG. 12. From the main menu segment 1102, the user can choose to manage features specific to particular schools on the system, manage features of the Site editor module 101, or manage users and passwords for the management module 102 by accessing links to a manage schools segment 1103, a manage application segment 1104, or a manage users segment 1105, respectively.

From the manage schools segment 1103, the user can choose to add a school to the system. The user is provided with a link to an add school segment 1110, where the user can add a school to the system. Illustratively, the user is required to enter a school name and the Federal Operating Expense (OE) Code associated with the school. Once a school is added to the system, a Web Site can be created for the school by a user of the Site editor module 101.

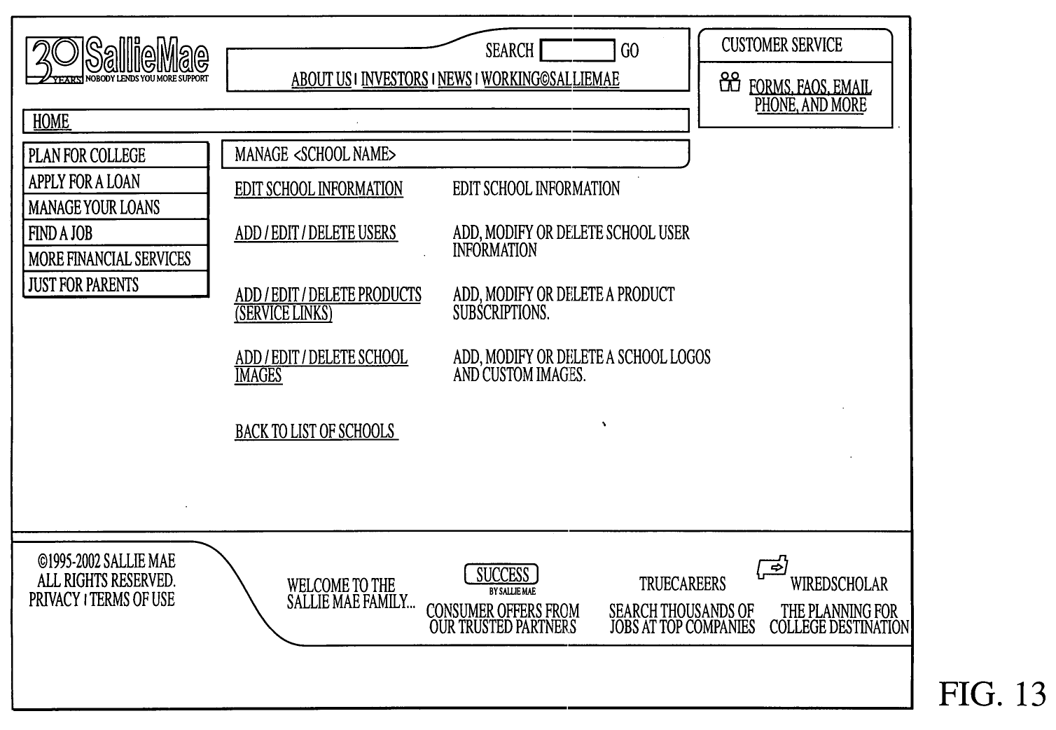

From the manage schools segment 1103, the user can also delete a specific school from the system or manage features related to a specific school. For example, the user is presented with a list of all schools on the system. From the list, the user can choose to delete a particular school from the system or to manage the school's information or Site editor features. Upon choosing to manage the school's information or Site editor features by accessing a link for a particular school, the user is taken to a manage school segment 1111 for the particular school. There is a manage school segment 1111 for each school on the system. A screen view of an exemplary manage school segment 1111 is shown in FIG. 13.

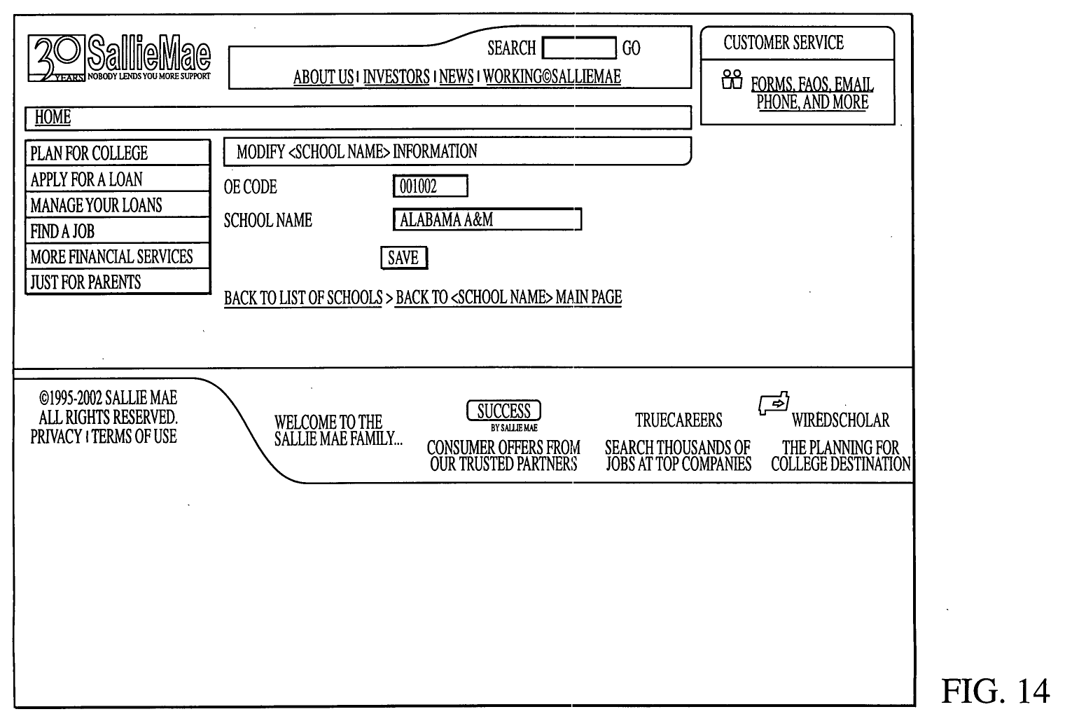

From a manage school segment 1111, the user can choose to modify school information, such as the school name and/or the Federal OE Code associated with the school, by accessing the modify information segment 1120. A screen view of an exemplary modify information segment 1120 is shown in FIG. 14.

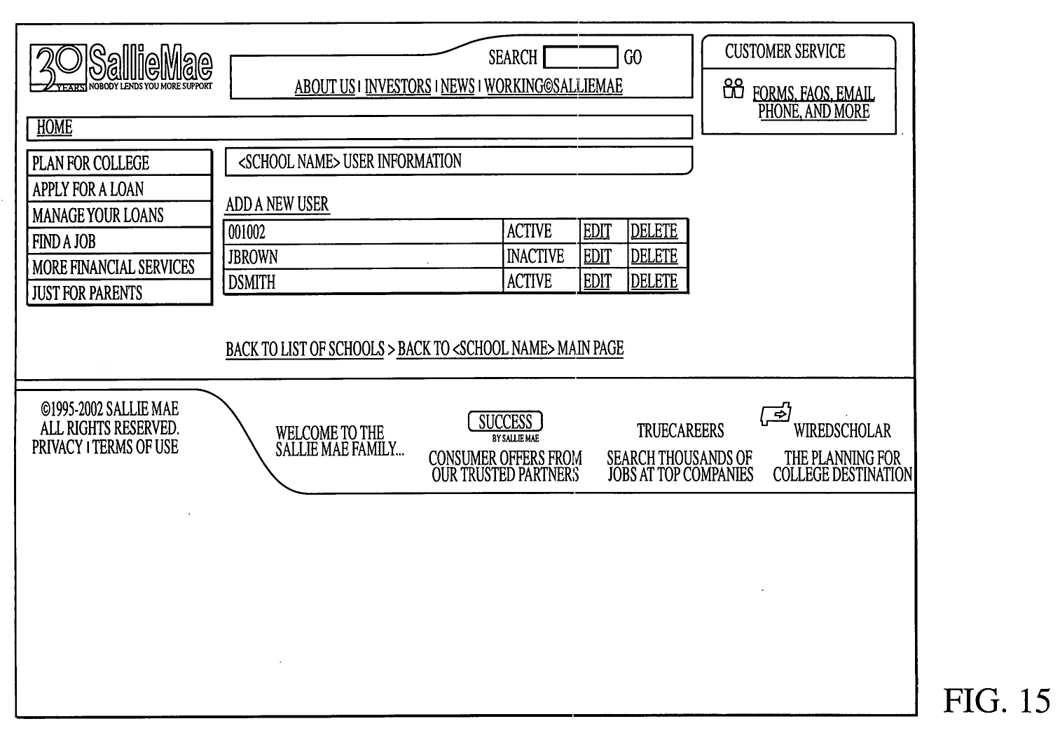

From a manage school segment 1111, the user may also add, edit, and delete users of the Site editor module 101 for the school (segment 1121). For this, the user can create or edit Site editor user names and associated passwords, as well as activate or inactivate particular Site editor users. A screen view of an exemplary add/edit/delete users segment 1121 is shown in FIG. 15. When a user adds (add user segment 1131) or edits information for a Site editor user (edit user segment 1132), the user enters or edits a Site editor user name and associated password. Also, the user can specify or change the status of the Site editor user to active or inactive.

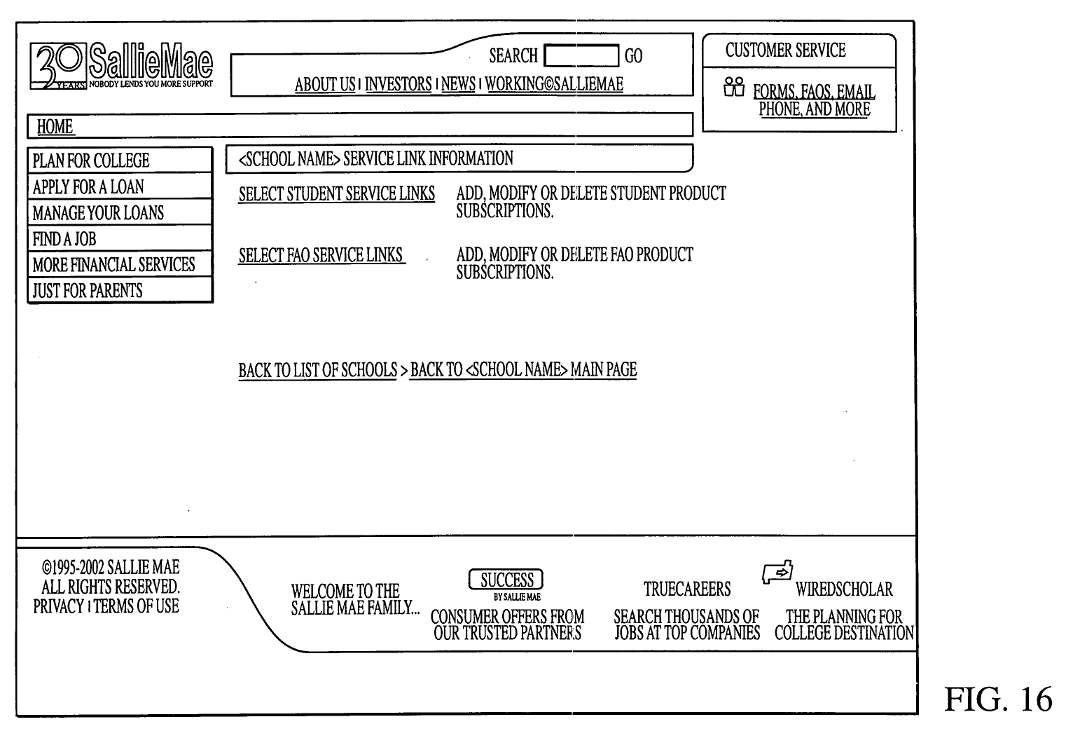

From a manage school segment 1111, the user can also add, edit, and delete links (segment 1122) available for a school's Web Site. A screen view of an exemplary add/edit/delete links segment 1122 is shown in FIG. 16. For this, a user can choose to add, edit, and delete links for each type of Web Site available to a Site editor user. For example, where the Site editor module 101 is configured to offer a Site editor user the option of creating a Web Site directed to students or to an FAO, the user can choose to add, edit, or delete links specific to student Web Sites, student links segment 1133, or to the FAO Web Sites, FAO links segment 1134.

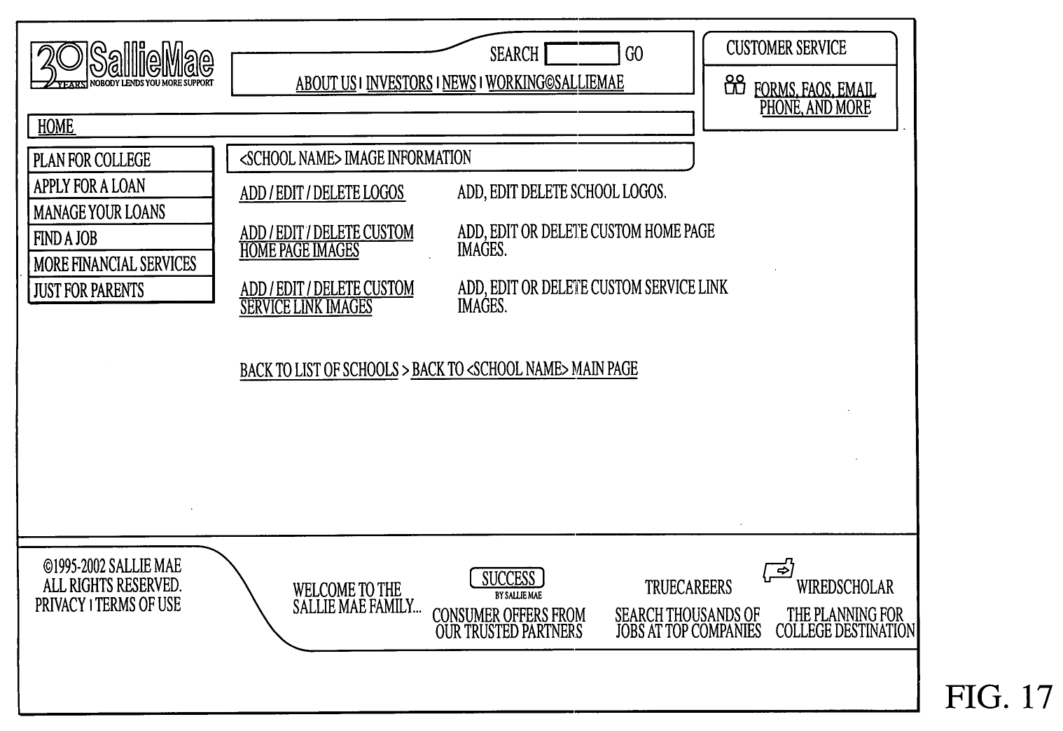

Additionally, the user can add, edit, and delete images available for the school's Web Site. A screen view of an exemplary add/edit/delete images segment 1123 is shown in FIG. 17. For this, the user can choose to add, edit, and delete images for different portions of a product access Web Site that are available to a Site editor user for a particular school. For example, the user can add, edit, and delete school logos from segment 1135, custom images for the home page of the school's product access Web Site from segment 1136, and custom images for links of the school's product access Web Site from segment 1137. To add or edit a logo, the user uploads a file containing a logo and saves the file to a system database by interfacing with add logo segment 1141 or edit logo segment 1142, respectively. Similarly, to add a custom home page or links image, the user uploads a file containing the image and saves the file to a system database by interfacing with add image segments 1143 or 1144, respectively.

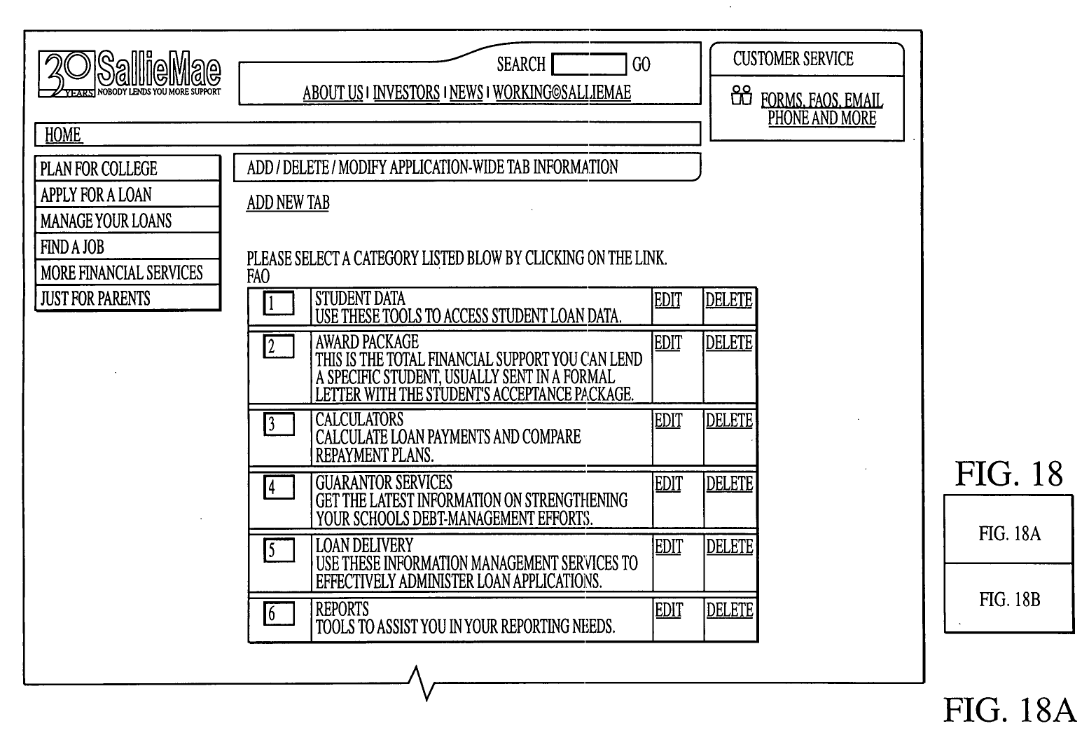

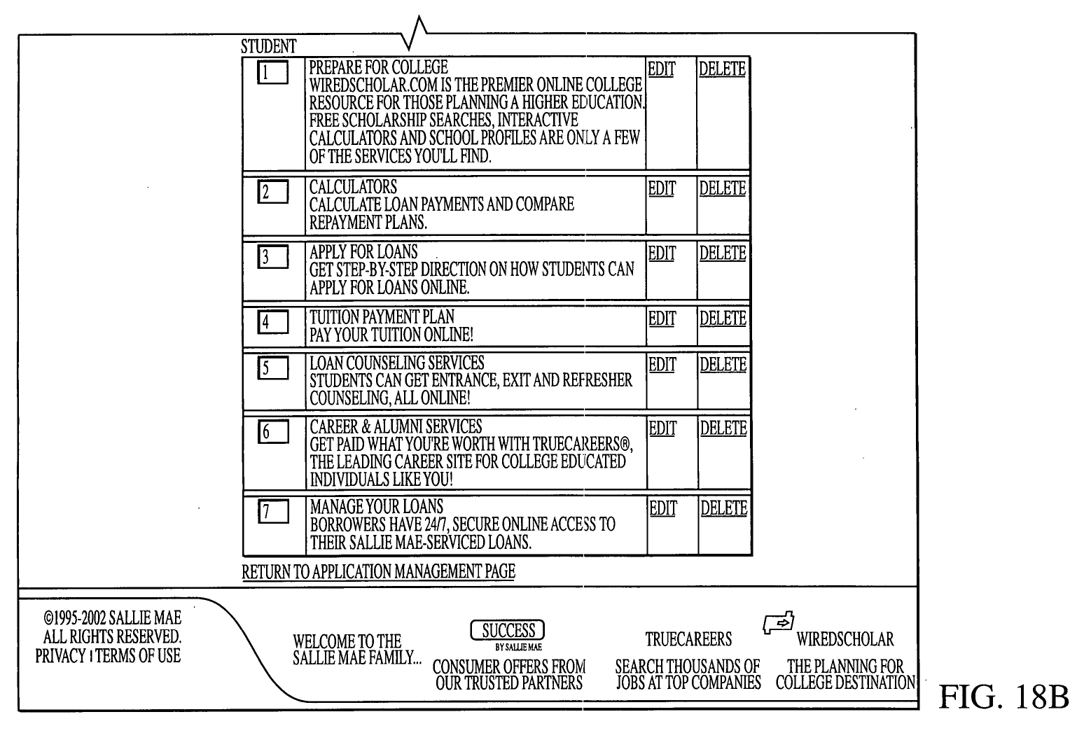

From the manage application segment 1104, the user can manage general features of the Site editor module 101. Changes made through the manage application segment 1104 are module wide and, therefore, affect features generally available to all Site editor users. From the manage application segment 1104, the user can choose to add, edit, and delete tabs, which will be the preset tabs available to users of the Site editor module 101. For this, the user is taken to the add/edit/delete tabs segment 1112. A screen view of an exemplary segment 1112 is shown in FIG. 18. When the user chooses to add or edit a tab, the user is taken to add tab segment 1161 or edit tabs segment 1162, respectively, to complete the tasks.

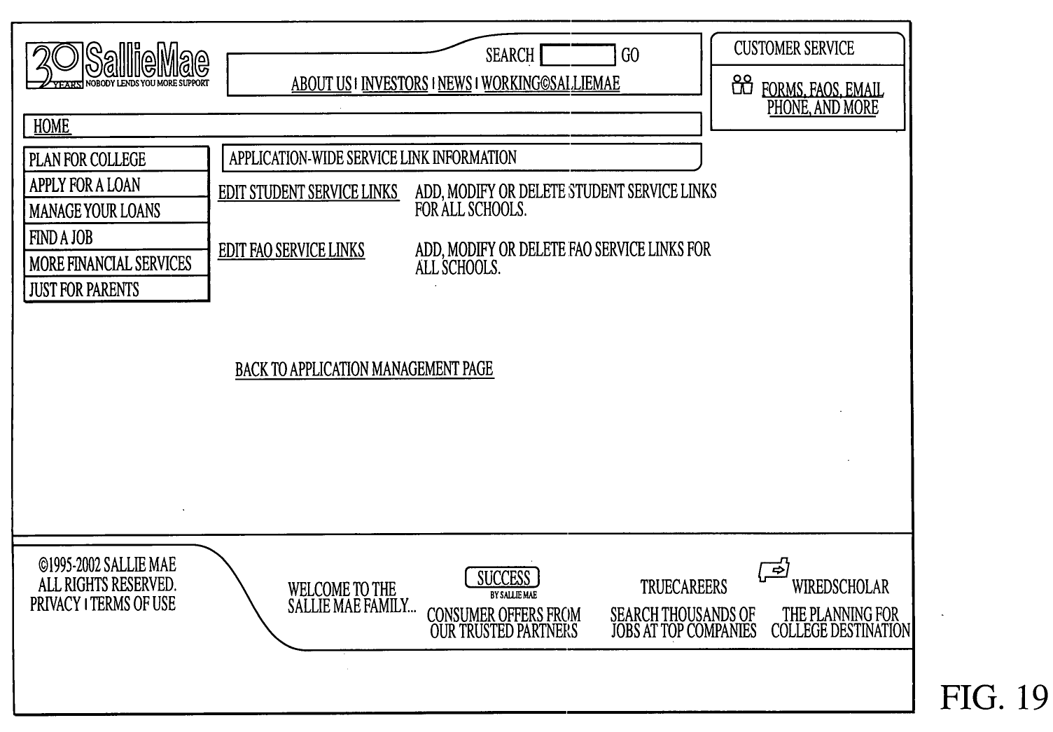

From the manage application segment 1104, the user can also choose to add, edit, and delete links, which will be the preset links available to users of the Site editor module 101. For this, the user can add, edit, and delete links separately for each type of product access Web Site, i.e. student and FAO, available in the Site editor module 101. Thereby, the user can tailor the available links based on the type of product access Web Site to allow a Site editor user to quickly and easily customize a product access Web Site. A screen view of an exemplary add/edit/delete links segment 1113 is shown in FIG. 19.

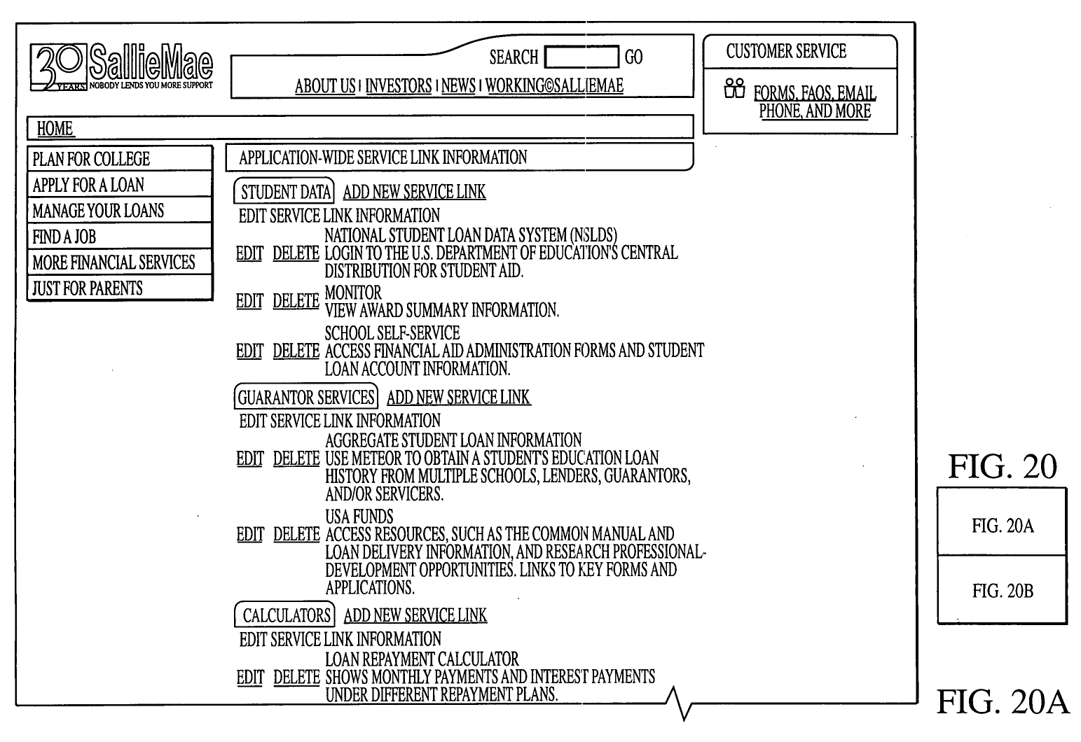

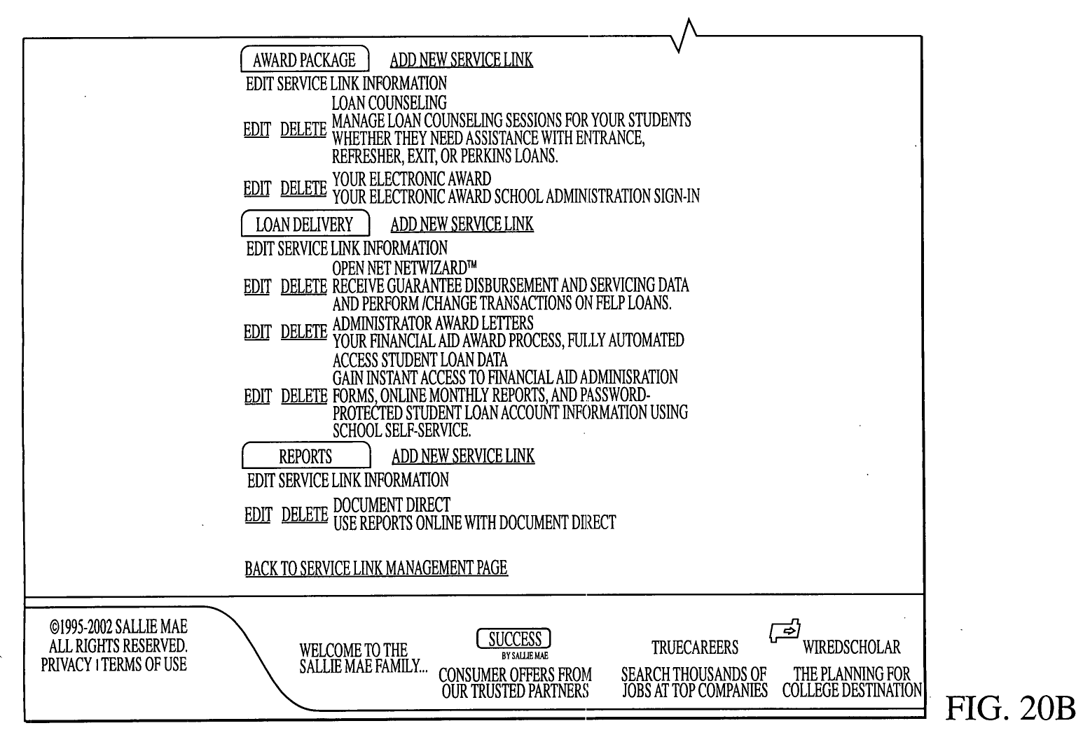

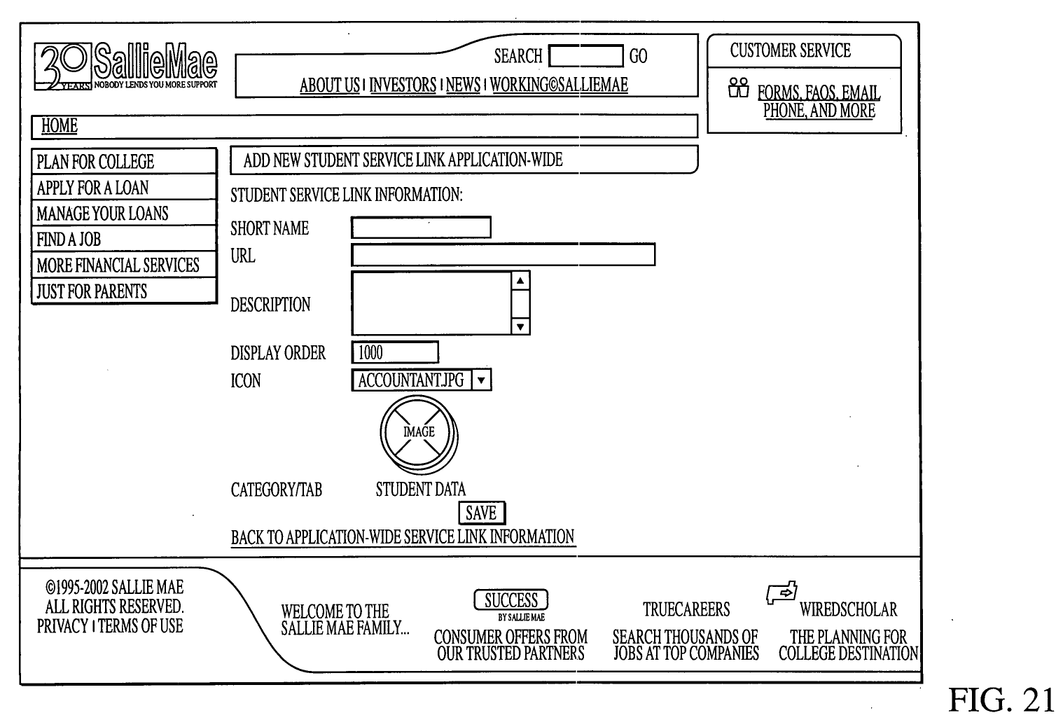

When a user chooses to add/edit, or delete links available for student Web Sites, the user is taken to student links segment 1152. A screen view of an exemplary segment 1152 is shown in FIG. 20. From student links segment 1152, if a user chooses to add or edit a link, the user is taken to one of add links segment 1161 or edit link segment 1162, respectively. A screen view of an exemplary add link segment 1161 is shown in FIG. 21.

From add link segment 1161, the user can enter information for a new link, such as a name, URL, a description of the link, and what tab(s) the link will be set to. The user can also specify a display order for the link, which will determine where a link appears relative to other preset links in the Site editor module 101. Additionally, the user can add an icon to appear with the link. The icon is an image selected from an image library described below. Edit link segment 1162 for editing an available link may be configured similarly to add link segment 1161 as shown in FIG. 21, except that information for the link chosen to be edited will appear in the respective fields.

When a user chooses to add/edit, or delete links available for FAO Web Sites, the user is taken to FAO links segment 1153, which may be configured similarly to student links segment 1152 as shown in FIG. 20, except that the links would be for products useful for an FAO.

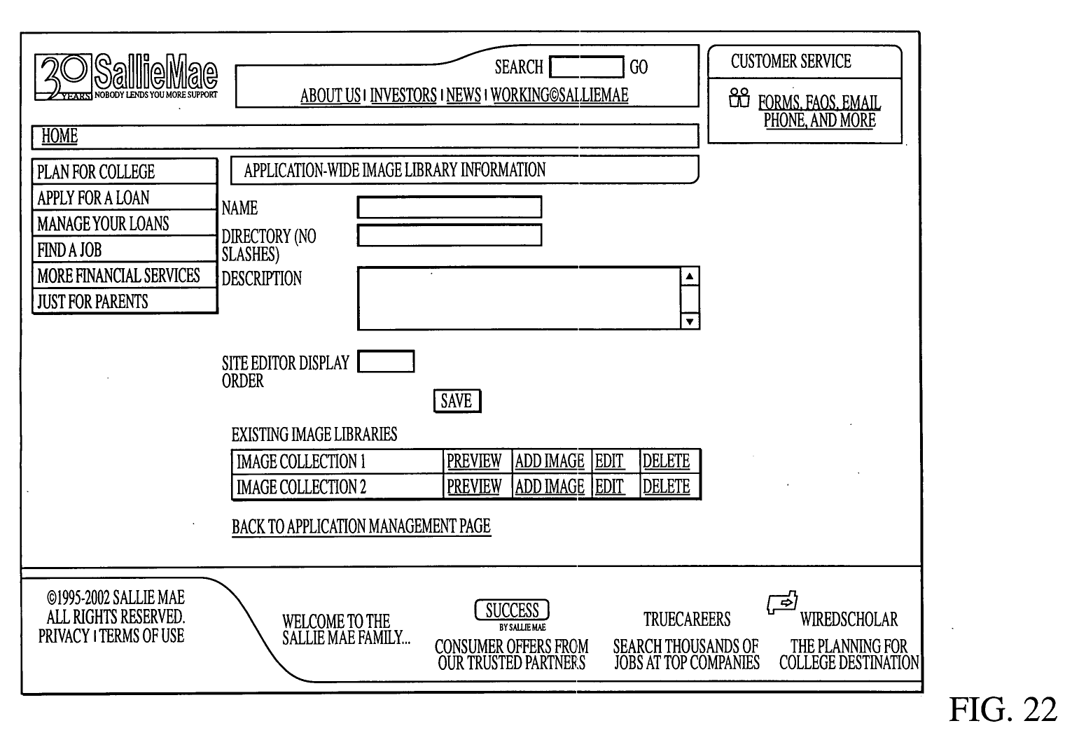

From the manage application segment 1104, the user can also choose to add, edit, and delete image libraries. For this, a user is taken to segment an add/edit/delete image libraries segment 1114. A screen view of an exemplary add/edit/delete image libraries segment 1114 is shown in FIG. 22. From segment 1114, the user can choose to create and delete image libraries, add and delete specific images to and from a particular image library, edit the information associated with an image library, or preview an image library.

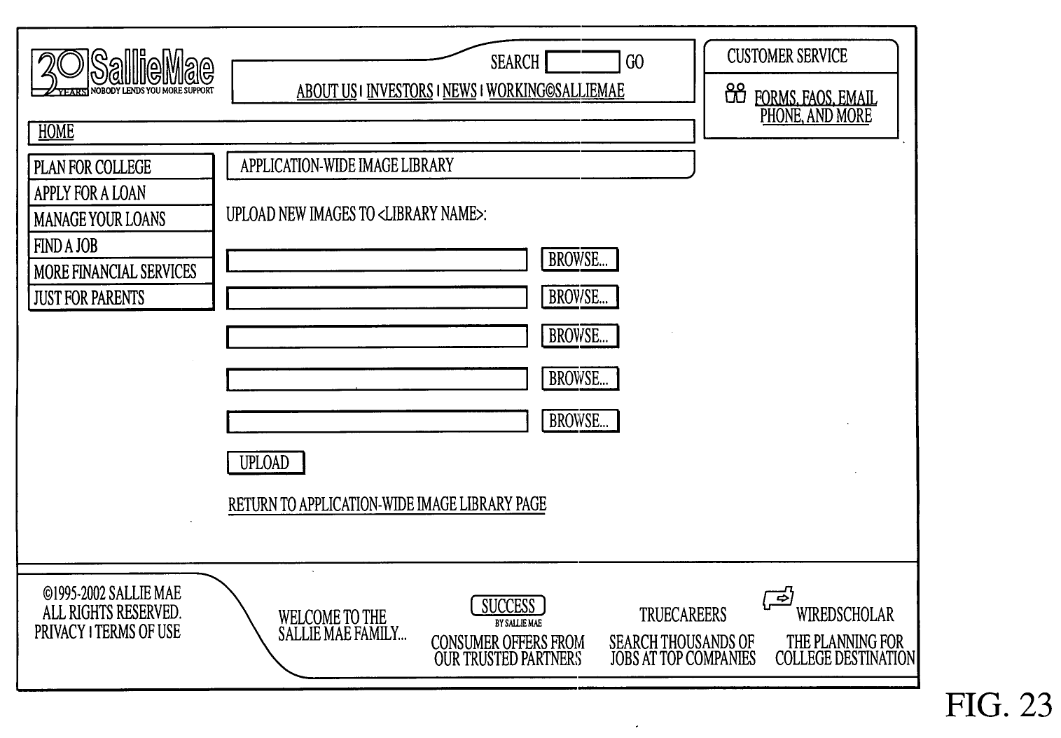

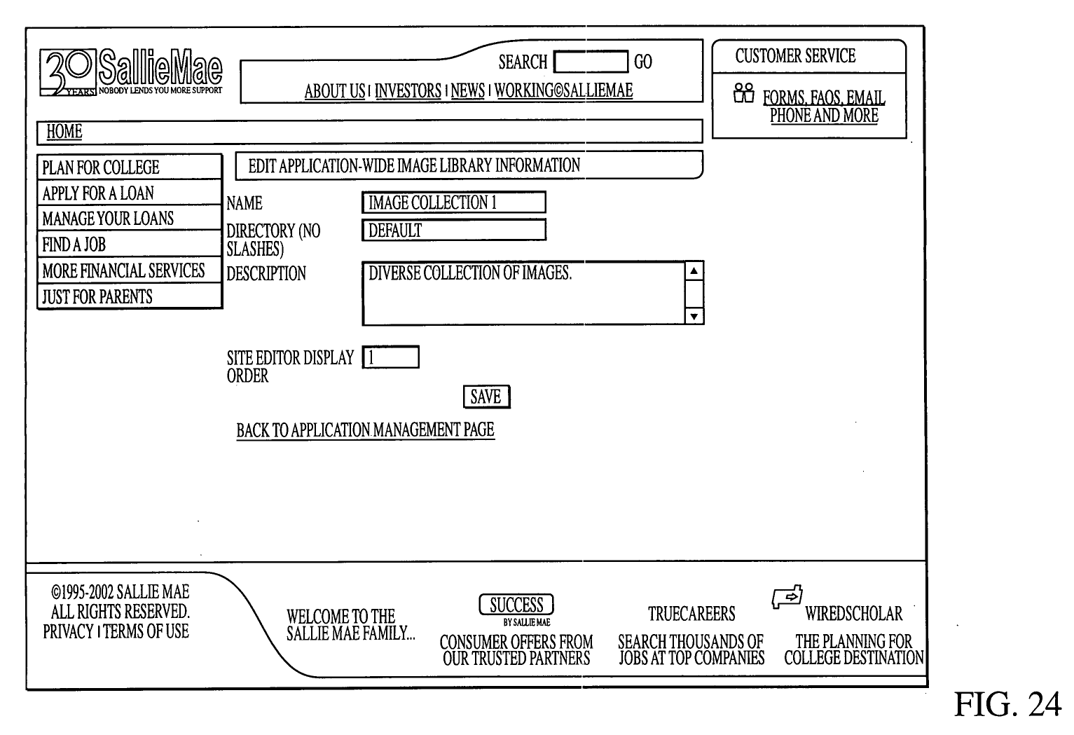

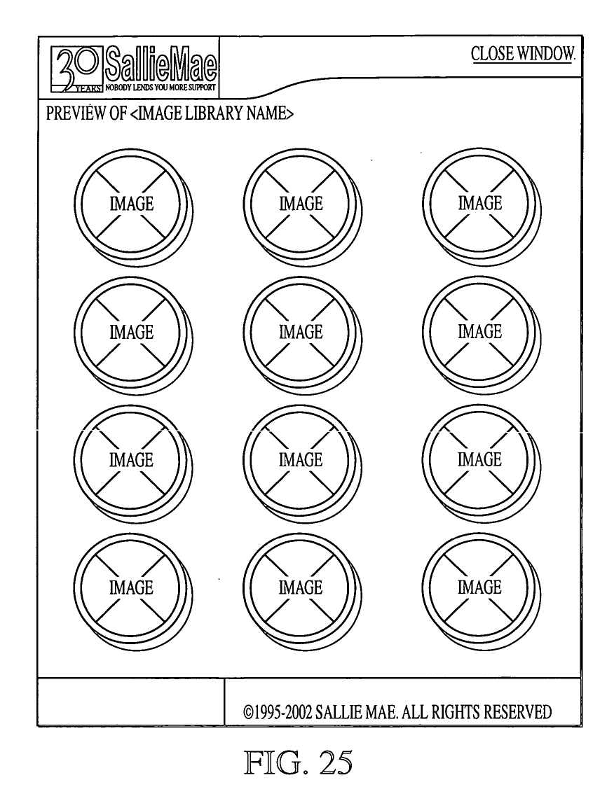

When a user chooses to add an image library, the user enters the library information requested on segment 1114, such as a name, the directory location for the image library, a description, and the display order for the library in the Site editor module 101. Once a library has been created, the user may add images to the library. For this, the user is taken to add images segment 1154. A screen view of an exemplary add images segment 1154 for uploading files containing images into an image library is shown in FIG. 23. The user can enter a number of file names, or browse for files, and then select to upload the entered files to the image library. The user can also choose to edit information for an image library (edit library segment 1155) or preview an image library to view each of the images in the library (preview library segment 1156). Screen views of exemplary edit library segment 1155 and preview library segment 1156 are shown in FIGS. 24 and 25, respectively.

### Single Sign-On Module

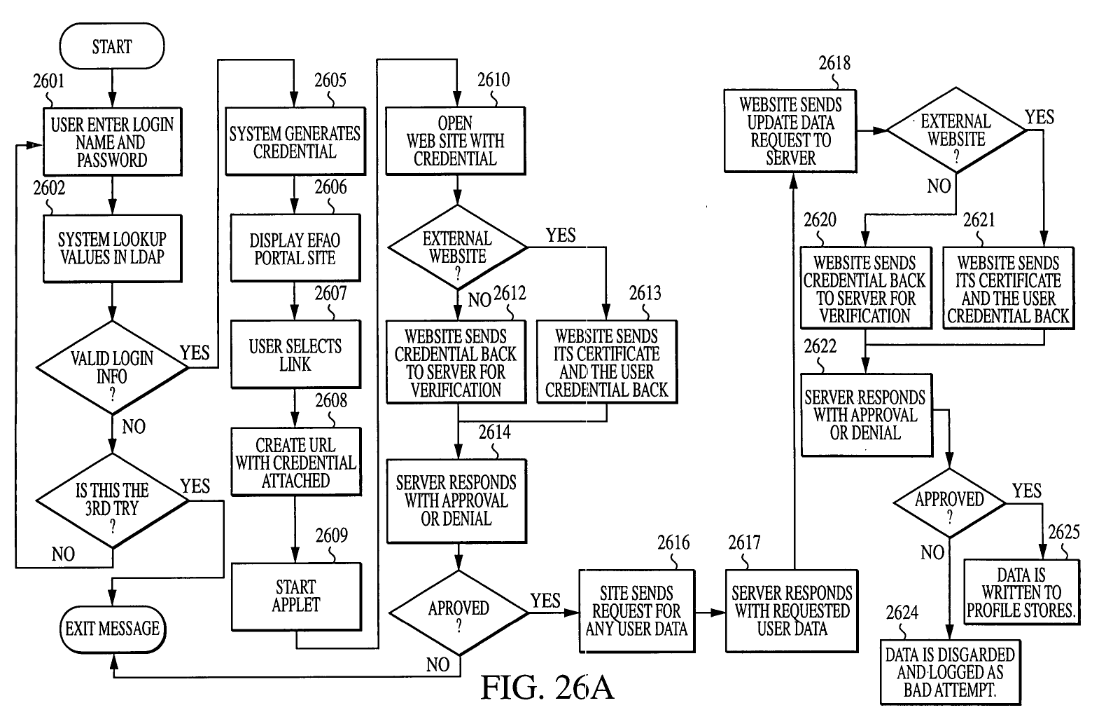

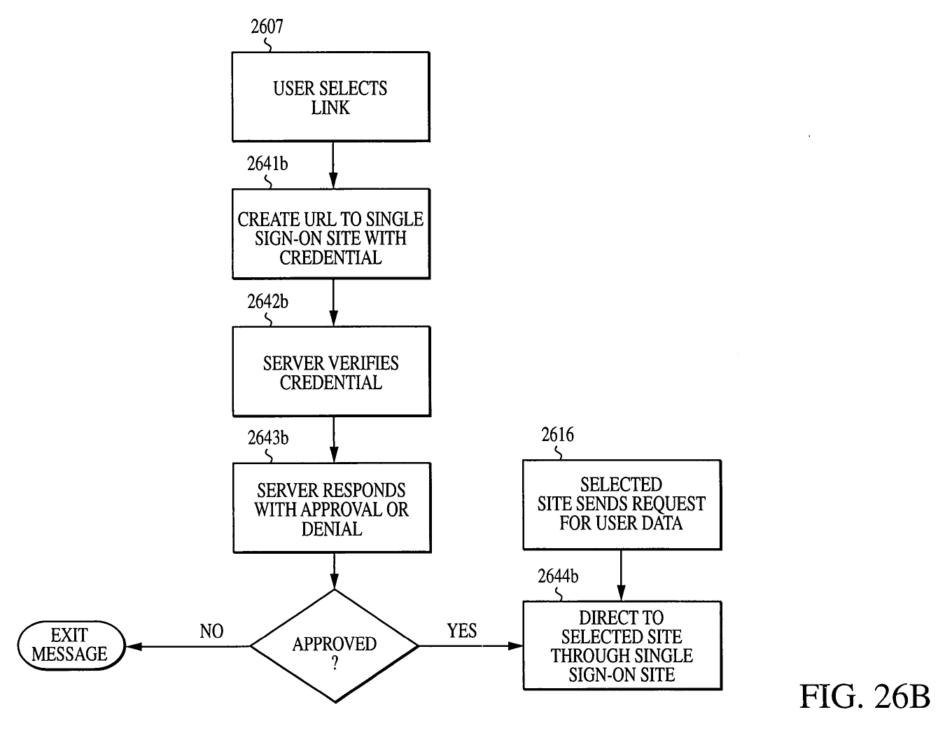

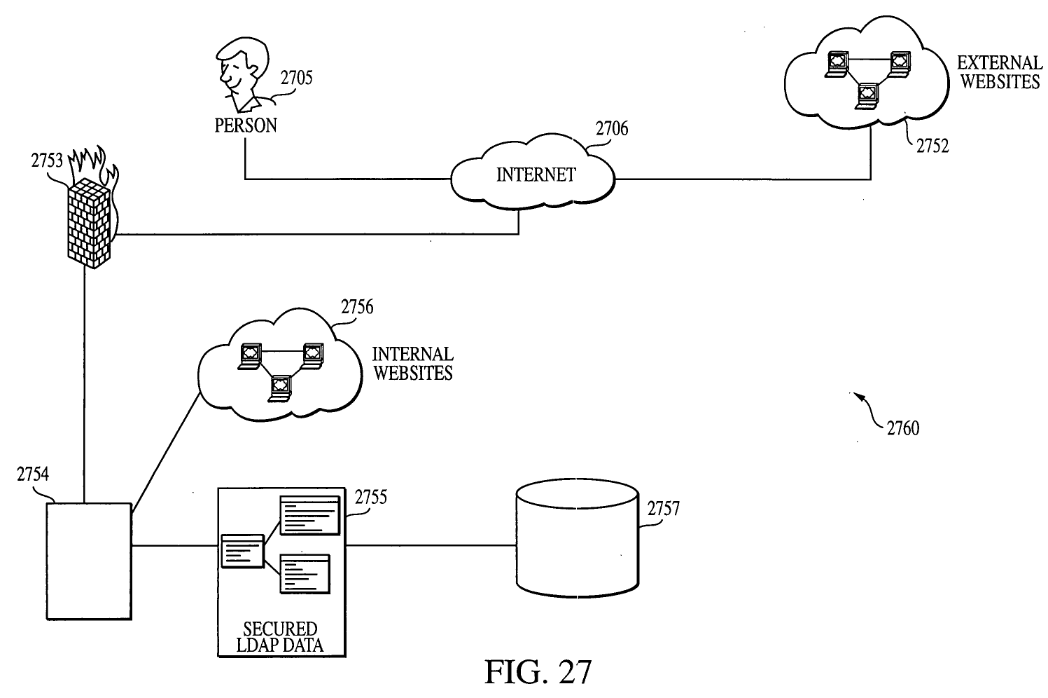

Referring to FIG. 1, the system 100 includes a single sign-on module 103 that allows a product access Web Site user, such as a student 105, to log in (sign on) to the system 100 one time and at one entry point to access all portions of the system 100 available to the particular user. FIG. 26A is a flow chart illustrating an exemplary single sign-on process for a user according to an exemplary embodiment of the invention. FIG. 27 is a schematic diagram illustrating an exemplary architecture of the single sign-on module 103 including a single sign-on server 2754.

The single sign-on module 103 comprises a computer program application product embodied on a computer useable medium and includes a number of code segments. The application runs on single sign-on server 2754, which is in communication with a computer network, for example, the Internet 2706. The single sign-on server 2754 includes a lightweight directory access protocol (LDAP) subsystem 2755, which is a secured storage location and may contain secure data, such as certificates, public and private keys, and user specific information, among others. LDAP subsystem 2755 includes an LDAP computer program application product running on single sign-on server 2754. Illustratively, the LDAP computer program application is Active Directory by Microsoft, but it can be any other appropriate LDAP application. LDAP subsystem 2755 has access to a database 2757, which contains general data related to users, such as demographic information. Database 2757 is secured using conventional security measures as are known in the art.

As shown in FIG. 26A, in segment 2601, a user 2705 enters login information, such as a user name and password combination, into a form on a user interface, for example a Web Page, which serves as an entry point to the single sign-on module 103.

Using, for example, the HTTP POST operation, the login name and password combination is transmitted to single sign-on server 2754. The transmission is encrypted using, for example, Secure Socket Layer (SSL).

The single sign-on module 103 communicates with single sign-on server 2754 in segment 2602 to look up the username and password combination. In segment 2603, if the login name and password is found, the single sign-on module 103 determines that the login information is valid and generates a unique credential that can be used to identify the user in segment 2705. If, however, single sign-on module 103 does not determine that the login information is valid in segment 2603, in segment 2604, single sign-on module 103 determines how many times the user has attempted to log in. If the user 2705 has attempted to log in a certain number of times, for example three times, the single sign-on module 103 presents the user 2705 with an exit message and is logged out of the system 100. If the user 2705 has attempted to login fewer than three times, then the user 2705 is permitted to attempt to log in again at segment 2601.

A credential can be a sequence of numbers and characters that is mathematically complex enough that it cannot be reverse engineered without a key association. In this example, the key association is the combination of the user's login name and password. The credential is presented back to the user 2705, for example, in the form of a javascript cookie. The cookie is written to the hard drive of the user's client computer. Once the user 2705 is presented with the credential, the single sign-on module 103 recognizes the user 2705 based on the credential, as well as the user login name and password. For additional security, the credential may be set to expire after a specified amount of time if not presented again.

In segment 2606, the system portal Site, which is the Site from which the user logged into the system 100, is displayed to the user. When the user selects a link to another Web Site, for example a link to a product located on another Web Site, in segment 2607, the single sign-on module 103 creates the URL for the selected Site with the credential attached in segment 2608. Accordingly, the established credential is passed to the Web Site accessed by the user.

When the user 2705 attempts to access another Web Site having a single sign-on applet, the applet starts as indicated in segment 2609. For example, a student may attempt to access another Web Site by selecting a link on a school Web Site created using the Site editor module 101. In order for the user 2705 to access a Web Site using the single sign-on module 103, the Web Site must have a single sign-on applet. The applet presents the previously created credential. For this, the applet reads the cookie from the user's computer hard drive.

The applet then creates a message and transmits the credential and message to the single sign-on server 2754 in segment 2612 or 2613 depending on whether the Web Site is an internal 2756 or external Site 2752. An internal Web Site 2756 is a Site that has direct access to and is trusted by the LDAP subsystem 2755. The message and the credential may be transmitted using SSL encryption for validation. Where the Web Site is an external Site 2752, the Web Site's certificate is also sent back to the server 2754 with the credential. An external Site 2752 is a Site that accesses the single sign-on server 2754 through, for example, the Internet 2706. Accordingly, there can be a firewall 2753 between the external Site and the single sign-on server 2754.

Single sign-on server 2754 takes the credential and looks up the entry in the LDAP subsystem 2755. If the credential is found, the presentation time is checked against the last presentation time to determine whether the credential has expired. If the credential has not expired, the presentation time is updated, and a new credential is generated, sent back to the Web Site, and written to the user's client computer hard drive in segment 2614. Also any additional function requests are completed in segment 2614; for example, a function request can be made to update information about the user's account or to view the audit history, which could include the user's last login time, the number of times the user accessed the system, and the products accessed by the user, among other things. If, however, the credential is not found or has expired, the server 2754 responds with a denial of access in segment 2614, and the user is logged out of the system 100.

In segment 2616, the credential is used to request data associated with the user 2750. For example the requested data can be demographic information such as address, date of birth, etc. For this, single sign-on server 2754 retrieves the requested data from the LDAP subsystem 2755 and database 2757, and server 2754 responds to the Web Site with the requested data.

For example, the user can be a student who selected a link to a product from a product access Web Site 104. The product is located on another Web Site, which includes a Web Page having a form, such as a student loan application. The Web Site containing the loan application communicates with single sign-on server 2754 to request the data related to the user that is required for the loan application form. Upon receiving the data from single sign-on server 2754, the data is pre-populated into the form. The user then has the option of changing the data or submitting the application as is.

In segment 2618 the Web Site sends a request to update the data associated with the user to server 2754 using the credential. Where the Web Site is an external Web Site 2752, the Web Site sends its certificate and the credential to the server 2754 for verification in segment 2621. Where the Web Site is an internal Web Site 2756, the Web Site sends the credential to the server 2754 for verification in segment 2620.

Verification may be completed as described above in connection with segment 2614. In segment 2622 the server 2754 responds with approval or denial. Upon approval, data containing the updated information is written to the database 2757 in segment 2625. Upon denial, the data is discarded in segment 2624.

For example, when a student user has completed an on-line student loan application, the student has entered or changed their name, address, and/or date of birth. Also, the user may have left pre-populated information unchanged. This information is sent back to the server 2754 to update these demographic items in database 2757. Thereby, the most recent information for a user can be maintained in database 2757.

Referring to FIG. 26B, in an alternative exemplary embodiment, when the user selects a link to another Web Site in segment 2607, the user is directed to the selected Site through a Single Sign-on Site located on single sign-on server 2754.

When the user selects a link to another Web Site, for example a link to a product, which is located on another Web Site, in segment 2607, the single sign-on module 103 creates a URL for a Single Sign-on Site located on the single sign-on server 254 with the credential attached in segment 2641a. In segment 2642a, the single sign-on server 2754 verifies the credential. For this, single sign-on server 2754 takes the credential and looks up the entry in the LDAP subsystem 2755.

If the credential is found, the presentation time is checked against the last presentation time to determine whether the credential has expired. If the credential has not expired, the presentation time is updated, and a new credential is generated, sent to the Single Sign-on Site Web Site, and written to the user's client computer hard drive in segment 2643b. If, however, the pair is not found or credential has expired, the server 2754 responds with a denial of access in segment 2643b, and the user is logged out of the system 100.

Upon approval, the user is directed to the selected Web Site through the Single Sign-on Web Site in segment 2644b, and the process continues to segment 2616 as described above in connection with FIG. 26A.

In another alternative exemplary embodiment, communication between the user's client computer and the system can be routed through a proxy server, e.g., proxy server 2815 (FIG. 28). A proxy server 2815 is a server that can communicate through multiple protocols. Where proxy server 2815 is used, the Single Sign-on process is similar to the first exemplary Single Sign-on process described above in connection with FIG. 26A, except that proxy server 2815 communicates directly with the client computer and acts the client computer when communicating with a remote system. Accordingly, proxy server 2815 maintains all login information and credentials required to access the remote system.

For example, when a user selects a link to another Web Site, such as a link to a product, the request is passed to proxy server 2815. Proxy server 2815 communicates with single sign-on module 103 to authenticate the user as described above. If the user is determined to be a valid user, proxy server 2815 acts as a gateway to the products accessed by the user. Proxy server 2815 establishes a connection to the remote server in place of the client computer. Also, proxy server 2815 passes along the credential to the remote server, captures the reply, then passes the reply back to the client computer, and communicates with single sign-on module 103.

### Network Architecture

The system and method described above may be part of a network. A diagram of exemplary system architecture 2800 for supporting a system and method for providing educational and financial services is shown in FIG. 28. The architecture 2800 shown in FIG. 28 is exemplary only, and other architectures can be employed to achieve the present invention.

As illustrated in FIG. 28, the system includes a primary redirector 2811 for distributing the inbound internet traffic 2810 among a group of servers, e.g., firewall servers 2818. Accordingly, after distribution by primary (or secondary) redirector 2811, the inbound internet traffic 2810 has been screened and is screened internet traffic 2814. The secondary redirector 2812 serves as a back up to primary redirector 2811. If primary redirector 2811 fails, secondary redirector 2812 takes over the functions of primary redirector 2811 to avoid service interruption.

The redirectors 2811, 2812 service firewall servers 2818. Firewall servers 2818 prevent outside network traffic from reaching the internal network for any unintended purpose. Firewall servers 2818 will also limit the protocol that will be allowed on a given Transmission Control Protocol/Internet Protocol (TCP/IP) port. For example, the firewall limits traffic to the TCP/IP port 80 or 443 in the case of the HTTP protocol.

The firewall servers 2818 then route the filtered traffic 2819 to the demilitarized zone (DMZ) redirectors 2820, 2821. DMZ redirector 2820 is illustratively a primary redirector and DMZ redirector 2821 is a secondary redirector in case DMZ redirector 2820 fails. DMZ redirectors 2820, 2821 distribute the filtered internet traffic 2819 evenly across Web servers, e.g., servers 2833 and 2834, to balance traffic 2819 among a cluster of servers.

Web servers 2833 and 2834 are located in the DMZ 2830 along with primary and secondary DMZ domain controllers 2831 and 2832, respectively. Primary and secondary DMZ domain controllers 2831 and 2832 create a trusted environment among Web servers 2833 and 2834. Once a server is authenticated against the domain, the other server will trust communication from that server as “safe.” Servers 2833 and 2834 can each be a cluster of servers and include Site editor module 101, management module 102, Single Sign-on module 103, and product access Web Site 104 (FIG. 1). Web servers 2833 and 2834 provide user interfaces and communicate with SQL server 2854 behind the firewall servers 2840 between the DMZ 2830 and internal network (CEN) 2850. Servers 2833 and 2834 also parse requests from traffic 2819 and format any response data to be passed out of the system.

There are also proxy servers 2815, 2816 that function as a gateway for screened internet traffic 2814 to Web servers 2833 and 2834. Proxy servers 2815, 2816 act as Web servers 2833 and 2834 when communicating with client computers. Further, proxy servers 2815, 2816 act as the client computer when communicating with a remote system as described above in connection with the single sign-on module 103.

CEN firewall servers 2840 provide a protective barrier from the DMZ to the internal network 2850. CEN firewall servers 2840 have stringent rules applied to them about network traffic. CEN firewall servers 2840 allow communications from one specific device to another on a specified TCP/IP port and protocol. For example, CEN firewall servers 2840 insure that a given Web Server can communicate only with SQL Server 2854 using only the protocol and TCP/IP port that SQL server 2854 would expect the communication to occur on.

The internal network 2850 includes SQL server 2854, batch process server 2853, primary and secondary CEN domain controllers 2851, 2852. SQL server 2854 is a cluster of SQL servers configured to be redundant and highly available. This allows for any single server within the cluster 2854 to fail without affecting the cluster 2854 from the perspective of a user. Batch process server 2953 processes functions that are not time sensitive in nature. For example, batch process server 2853 will process maintenance jobs that delete old or unused files, processing uploaded files, or large long running reports.

The CEN domain controllers 2851, 2852 function similarly to the DMZ domain controllers 2831, 2832. Accordingly, CEN domain controllers 2851, 2852 create a trusted environment for the servers 2853, 2854 to communicate with each other once they are authenticated to the internal network domain 2850.

The processes and devices described above illustrate preferred methods and typical devices of many that could be used and produced. The above description and drawings illustrate exemplary embodiments, which achieve the objects, features, and advantages of the present invention. It is not intended, however, that the present invention be strictly limited to the above-described and illustrated embodiments. Any modifications of the present invention that come within the spirit and scope of the following claims should be considered part of the present invention.

What is claimed as new and desired to be protected by Letters Patent of the United States is:

1. A computer system for financial aid, the system comprising:
a computer network;
at least one server in communication with the computer network;
at least one product access Web Site linked to the server through the computer network, the Web Site providing a user interface through which a first user can select from among a plurality of financial aid products;
a sign-on module that interacts with the Web Site and controls access to the financial aid products, wherein the sign-on module can provide access to any the financial aid products after receiving valid login information a single time until the first user is logged out of the system.

2. The system of claim 1, wherein the sign-on module comprises at least one database storing data associated with the first user, wherein the sign-on module is configured to provide data associated with the first user to a Web site containing a product accessed by the user.

3. The system of claim 2, wherein the sign-on module is configured to update the data associated with the first user and store the updated data in the database.

4. The system of claim 2, wherein the data comprises demographic data.

5. The system of claim 1, wherein the plurality financial aid products are such that the first user can complete the process of applying for and receiving financial aid using only the plurality of financial aid products.

6. The system of claim 1, further comprising a Site editor module that provides a user interface through which a second user can create and modify a product access Web Site by a preset process and receives input related to the preset process.

7. The system of claim 1, further comprising a Site editor module that provides a user interface through which a second user can modify a product access Web Site by a preset process and receives input related to the preset process.

8. The system of claim 6, wherein the Site editor module is located on a system server in communication with the computer network.

9. The system of claim 6, wherein the user interface provided by the Site editor module is a voice user interface.

10. The system of claim 6, wherein the user interface provided by the Site editor module comprises instructions related to the preset process.

11. The system of claim 6, wherein the Site editor module provides a user interface through which the second user can select the financial aid products from among a plurality of preset financial aid products and receives input for selecting the financial aid products.

12. The system of claim 11, wherein the plurality of preset financial aid products comprises a student financial aid application, student loan application product, a student loan counseling product, and an electronic financial aid award package product.

13. The system of claim 6, wherein the Site editor module provides a user interface through which the second user can view a representation of the product access Web Site reflecting the input related to the preset process received, at a time the preset process related input is received.

14. The system of claim 6, wherein the Site editor module collects data related to the usage of the product access Web Site and provides a user interface through which the second user can view the usage data.

15. The system of claim 6, further comprising a management module that provides a user interface through which a third user can affect portions of the Site editor module and receives input related to the portions of the Site editor module.

16. The system of claim 15, wherein the management module is located on a system server in communication with the computer network.

17. The system of claim 15, wherein the management module provides a user interface through which the third user can determine the plurality of preset financial aid products and receives input determining the preset financial aid products.

18. A system for educational financial aid service, the system comprising:
at least one server;
at least one product access Web Site located on the server that provides a product access user interface through which a first user can select links to a plurality of financial aid products;
a sign-on module that receives login information related to the first user and interacts with the at least one product access Web Site to control the first user's access to the plurality of financial aid products, wherein the sign-on module is configured such that the first user can access any one or more of the plurality of financial aid products after entering valid login information until the Web Site user is logged out of the system;
a Site editor module enabling a second user to create and modify a product access Web Site by a preset process;
a management module enabling a third user to affect the preset process.

19. A computer network for enabling financial aid service, the network comprising:
at least one server in communication with the computer network;
at least one product access Web Site linked to the server through the computer network, the Web Site providing a user interface through which a first user can select from among a plurality of financial aid products;
a sign-on module that interacts with the Web Site and controls access to the financial aid products, wherein the sign-on module can provide access to the financial aid products after receiving valid login information a single time until a user is logged out of the system; and
a Site editor module that provides a user interface through which a second user can create and modify a product access Web Site by a preset process and receives input related to the preset process.

20. The network of claim 19, wherein the sign-on module comprises at least one database storing data associated with the first user, wherein the sign-on module is configured to provide data associated with the first user to a Web site containing a product accessed by the user.

21. The network of claim 20, wherein the sign-on module is configured to update the data associated with the first user and store the updated data in the database.

22. The network of claim 20, wherein the data comprises demographic data.

23. The network of claim 19, wherein the Site editor module is located on a network server in communication with the computer network.

24. The network of claim 19, wherein the user interface provided by the Site editor module is a voice user interface.

25. The network of claim 19, wherein the user interface provided by the Site editor module comprises instructions related to the preset process.

26. The network of claim 19, wherein the Site editor module provides a user interface through which the second user can select the financial aid products from among a plurality of preset financial aid products and receives input for selecting the financial aid products.

27. The network of claim 26, wherein the plurality of preset financial aid products comprises a student financial aid application product, student loan application product, a student loan counseling product, and an electronic financial aid award package product.

28. The network of claim 19, wherein the Site editor module provides a user interface through which the second user can view a representation of the product access Web Site reflecting the input related to the preset process received, at a time the preset process related input is received.

29. The network of claim 19, wherein the Site editor module collects data related to the usage of the product access Web Site and provides a user interface through which the second user can view the usage data.

30. The network of claim 19, further comprising a management module that provides a user interface through which a third user can affect portions of the Site editor module and receives input related to the portions of the Site editor module.

31. The network of claim 30, wherein the management module is located on a network server in communication with the computer network.

32. The network of claim 30, wherein the management module provides a user interface through which the third user can determine the plurality of preset financial aid products and receives input determining the plurality of preset financial aid products.

33. A computer software program product for financial aid embodied on a computer useable medium, comprising:
at least one product access application that runs on a server in communication with a computer network that provides a user interface through which a first user can select from among a plurality of financial aid products;
a sign-on application that interacts with the Web Site and controls access to the financial aid products, wherein the sign-on module can provide access to the financial aid products after receiving valid login information a single time until a user is logged out of the system; and

34. The computer program product of claim 33, wherein the sign-on application has access to at least one database storing data associated with the first user, wherein the sign-on application provides data associated with the first user to a Web site containing a product accessed by the user.

35. The computer program product of claim 34, wherein the sign-on application updates the data associated with the first user and stores the updated data in the database.

36. The computer program product of claim 34, wherein the data comprises demographic data.

37. The computer program product of claim 33, wherein the plurality financial aid products are such that the first user can complete the process of applying for and receiving financial aid using only the plurality of financial aid products.

38. The computer program product of claim 33, further comprising a Site editor application that provides a user interface through which a second user can create and modify the at least one product access application by a preset process and receives input related to the preset process.

39. The computer program product of claim 38, wherein the Site editor application runs on a server in communication with the computer network.

40. The computer program product of claim 38, wherein the user interface provided by the Site editor application is a voice user interface.

41. The computer program product of claim 38, wherein the user interface provided by the Site editor application comprises instructions related to the preset process.

42. The computer program product of claim 38, wherein the Site editor module provides a user interface through which the second user can select the financial aid products from among a plurality of preset financial aid products and receives input for selecting the financial aid products.

43. The computer program product of claim 42, wherein the plurality of preset financial aid products comprises a student financial aid application, student loan application product, a student loan counseling product, and an electronic financial aid award package product.

44. The computer program product of claim 38, wherein the Site editor application provides a user interface through which the second user can view a representation of the product access application reflecting the input related to the preset process received, at a time the preset process related input is received.

45. The computer program product of claim 38, wherein the Site editor application collects data related to the usage of the product access application and provides a user interface through which the second user can view the usage data.

46. The computer program product of claim 38, further comprising a management application that provides a user interface through which a third user can affect portions of the Site editor application and receives input related to the portions of the Site editor application.

47. The computer program product of claim 46, wherein the management application runs on a server in communication with the computer network.

48. The computer program product of claim 46, wherein the management application provides a user interface through which the third user can determine the plurality of preset financial aid products and receives input determining the preset financial aid products.

49. A method of providing for educational financial aid service, the method comprising:
providing at least one product access Web Site located on a system server in communication with a computer network that provides a user interface through which a first user can select links to a plurality of financial aid products;
receiving input by a first user selecting one or more links;
controlling the first user's access to at least a portion of the plurality of financial aid products using a sign-on module of the system; wherein the act of controlling the first user's access comprises receiving login information input a single time by the first user, determining whether the login information is valid, and, when the login information is valid, enabling the first user to access any one or more of the plurality of financial aid products until the first user exits the sign-on module.

50. The method of claim 49, wherein the plurality financial aid products are such that the first user can complete the process of applying for and receiving financial aid using only the plurality of financial aid products.

51. The method of claim 49, wherein the act of enabling the first user to access any one or more of the plurality of financial aid products comprises passing a credential associated with the first user to a server hosting a financial aid product.

52. The method of claim 49, further comprising:
under control of the sign-on module, transmitting data related to the first user and stored in a system database to a server hosting a financial aid product.

53. The method of claim 52, further comprising:
receiving updated data related to the first user from the server hosting the financial aid product; and
storing the updated data to the system database.

54. The method of claim 49, further comprising:
providing at least one system server computer running a Site editor application and in communication with the computer network, the Site editor application providing a user interface through which a second user can create and modify the product access Web Site according to a preset process, the user interface including instructions related to the preset process; and
receiving input for creating or modifying the product access Web Site.

55. The method of claim 54, wherein the act of providing a user interface through which a second user can create and modify the product access Web Site comprises providing a user interface through which a second user can select the links to the plurality of financial aid products from a plurality of preset links, and wherein the act of receiving input comprising receiving input selecting the links.

56. The method of claim 54, wherein the act of providing a user interface through which a second user can create and modify the product access Web Site comprises providing a user interface through which a second user can create at least a portion of the links to the plurality of financial aid products and wherein the act of receiving input comprising receiving input creating at least a portion of the links.

57. The method of claim 54, further comprising:
under control of the Site editor application, collecting usage data regarding the usage of the product access Web site; and
outputting the usage data via a user interface through which the second user can view the usage data.

58. The method of claim 54, further comprising:
providing at least one system server computer running a management application and in communication with the computer network, the management application providing a user interface through which a third user can affect the Site editor application; and
receiving input affecting the Site editor application.

59. The method of claim 58, wherein the act of providing a user interface through which a third user can affect the Site editor application comprises providing a user interface through which the third user can determine a preset links to a plurality of financial aid products, and wherein the act of receiving input comprises receiving input determining the preset links.
